(19) United States
(12) Patent Application Publication
(10) Pub. No.: US 2025/0112770 A1
(43) Pub. Date: Apr. 3, 2025

(54) METHODS AND APPARATUS TO SECURELY PERFORM CONFIGURATION UPDATES

(71) Applicant: Intel Corporation, Santa Clara, CA (US)

(72) Inventors: Dan Horovitz, Rishon Letzion (IL); Liron Ain-Kedem, Kiryat Tivon (IL); Guy Ben-Artzi, Zichron Yaacov (IL)

(73) Assignee: Intel Corporation, Santa Clara, CA (US)

(21) Appl. No.: 18/979,047

(22) Filed: Dec. 12, 2024

(51) Int. Cl. H04L 9/14; H04L 9/08; H04L 9/32

(52) U.S. Cl. CPC H04L 9/14; H04L 9/0861; H04L 9/3263

(57) ABSTRACT

Disclosed examples generate an original equipment manufacturer (OEM) private key and an OEM public key; generate an OEM certificate based on the OEM public key; cause sending of the OEM certificate from an OEM product to a silicon provider, the silicon provider to sign the OEM certificate based on a silicon provider private key; and cause storage of the signed OEM certificate in the OEM product.

### BACKGROUND

In electronic product manufacturing, an original equipment manufacturer (OEM) can buy semiconductor chips from a silicon provider (e.g., a chip manufacturer). Such semiconductor chips may be voltage regulators, counters, timers, memories, transmitters, receivers, controllers, processors, imaging sensors, etc. An OEM can design and manufacture OEM products using the semiconductor chips. Such OEM products can then be purchased by customers to integrate into larger systems.

### BRIEF DESCRIPTION OF THE DRAWINGS

FIG. 1 is a block diagram of an example environment in which an example configuration controller of an original equipment manufacturer (OEM) product operates to securely perform configuration updates of the OEM product and/or a system in which the OEM product is incorporated.

FIG. 2 is an example process flow diagram to provision a system-on-chip (SoC), create a signature of an OEM certificate, sign configuration data, and use the signed configuration data.

FIG. 3 is an example process flow diagram of the chip provisioning phase and the key generation and certificate signing phase of FIG. 2.

FIG. 4 is an example process flow diagram in which the OEM product of FIGS. 1-3 self-signs configuration data as part of the sign configuration data phase of FIG. 2.

FIG. 5 is an example process flow diagram to verify and use the signed configuration data of FIG. 4 as part of the configuration data verification and update phase of FIG. 2.

FIG. 6 is an example process flow diagram to change a default password for the OEM product of FIGS. 1-5 using an example signing tool.

FIG. 7 is an example process flow diagram in which the signing tool of FIG. 6 signs configuration data for the OEM product of FIGS. 1-5.

FIG. 8 is a block diagram of an example implementation of the configuration controller of FIG. 1.

FIG. 9 is a flowchart representative of example machine readable instructions and/or example operations that may be executed, instantiated, and/or performed by example programmable circuitry to implement the configuration controller of FIG. 8.

FIG. 10 is a flowchart representative of example machine readable instructions and/or example operations that may be executed, instantiated, and/or performed by example programmable circuitry to implement the configuration controller of FIG. 8 to obtain a signature of an OEM certificate.

FIG. 11 is a flowchart representative of example machine readable instructions and/or example operations that may be executed, instantiated, and/or performed by example programmable circuitry to implement the configuration controller of FIG. 8 to sign configuration data for an OEM product.

FIG. 12 is a flowchart representative of example machine readable instructions and/or example operations that may be executed, instantiated, and/or performed by example programmable circuitry to implement the configuration controller of FIG. 8 to update configuration data in an OEM product.

FIG. 13 is a block diagram of an example processing platform including programmable circuitry structured to execute, instantiate, and/or perform the example machine readable instructions and/or perform the example operations of FIGS. 9-12 to implement the configuration controller of FIG. 8.

FIG. 14 is a block diagram of an example implementation of the programmable circuitry of FIG. 13.

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine readable instructions of FIGS. 9-12 to client devices associated with end users and/or consumers (e.g., for license, sale, and/or use), retailers (e.g., for sale, re-sale, license, and/or sub-license), and/or OEMs (e.g., for inclusion in products to be distributed to, for example, retailers and/or to other end users such as direct buy customers).

In general, the same reference numbers will be used throughout the drawings and accompanying written description to refer to the same or like parts. The figures are not necessarily to scale.

### DETAILED DESCRIPTION

Examples disclosed herein perform secure configuration updates in electronic products in zero-trust environments. An original equipment manufacturer (OEM) manufactures products based on parts sourced from other manufacturers. For example, an OEM may source semiconductor chips of various functionalities from one or more silicon providers. In examples disclosed herein, such semiconductor chips are referred to as SoC chips and may include one or more of imaging sensor chips, audio sensor chips, machine vision chips, processors, hardware accelerators, storage chips, memory chips, transmitters, receivers, etc. An OEM product incorporating one or more SoC's may receive one or more post-manufacturing configuration updates. Such configuration updates may affect performance, safety, security, and/or any other aspect of the OEM product. To substantially eliminate or decrease the likelihood that malicious actors can use configuration updates to infiltrate functionality or data in the OEM products, examples disclosed herein perform such updates in a secure manner.

Examples disclosed herein may be used with any type of product that receives updates from time-to-time after manufacturing of the product. For example, camera calibration is a fundamental task in computer vision which is used in various applications such as three-dimensional (3D) reconstruction, object tracking, augmented reality, and image analysis. Accurate calibration ensures precise measurements and reliable analyses by correcting distortions and estimating intrinsic and extrinsic camera parameters.

Example OEM products that may incorporate examples disclosed herein are vision cameras. Such vision cameras are sometimes used and categorized as “safety cameras” which can be used for the safe operation of industrial and autonomous mobile robots. In safety cameras, updates to safety zones and in-field calibration are treated on the basis of zero trust. In examples disclosed herein, zero trust refers to the understanding that no user, process, or data is to be trusted by default and that identities and/or authorizations are to be verified before allowing configuration changes (e.g., updates to OEM products and/or systems that include the OEM products) or before allowing access to a resource (e.g., access to OEM products).

Examples disclosed herein may be used to protect updates to safety zones and in-field calibration in terms of security and/or safety of systems that use safety cameras as part of their vision technology. When a safety camera (e.g., an OEM product) is integrated into an industrial and autonomous mobile robot (e.g., a system), the safety camera monitors an environment of the robot to detect whether any person or protected object/obstacle is in a danger zone adjacent the robot. This type of monitoring is done to prevent the robot from making damaging physical contact with persons or protected objects.

Examples disclosed herein may be used to protect any type of OEM product (e.g., safety cameras, sensors, electronic devices, electro-mechanical devices, etc.) and/or system (e.g., industrial machines, computers, consumer electronics, robots, appliances, vehicles, etc.) that incorporates such OEM product from malicious access so that they operate correctly. Without such protection and treatment under zero trust policies, malicious updates could be used to hack or corrupt OEM products without detection. In safety cameras, such attacks could lead to robots becoming unsafe and dangerous to people or objects in their surroundings.

After an OEM manufactures and sells an OEM product, the OEM product can be incorporated into a system, and the system can be integrated into a process. For example, returning to the robot example described above, a system manufacturer, such as a robot manufacturer, may purchase safety cameras from the OEM and incorporate them into industrial and autonomous mobile robots. A system integrator may purchase the industrial and autonomous mobile robots from the system manufacturer and install them in a customer process (e.g., a warehouse environment, a manufacturing environment, a distribution center, a retail environment, etc.). Configuration updates may be performed on the OEM products and/or the systems (e.g., industrial machines, computers, consumer electronics, robots, appliances, vehicles, etc.) that include the OEM products from time to time. Such configuration updates may be used to update software, firmware, safety parameters, calibration parameters, etc.

In the example of industrial and autonomous mobile robots, after a safety camera has left the OEM, operations performed in association with the safety camera are referred to as being done in the field (e.g., at a system manufacturer, a system integrator, a customer environment, etc.). In examples disclosed herein, an in-field environment is outside the reach of the OEM that provided the OEM product (e.g., safety cameras, sensors, electronic devices, electro-mechanical devices, etc.) and outside the reach of a silicon provider that provided a SoC incorporated in the OEM product. In examples disclosed herein, configuration updates performed at in-field environments are referred to as zero trust actions.

Example in-field update operations associated with OEM products used in autonomous systems include obstruction awareness configurations and self-integrity awareness configurations. Obstruction awareness configurations define parameters such as locations and/or sizes of danger zones in a surrounding environment. Self-integrity awareness configurations define parameters associated with self-diagnostic routines and/or self-monitoring routines that check for operability and/or performance of sensors, processors, hardware, software, firmware, etc. involved in monitoring for obstructions and/or making decisions based on detected obstructions.

In safety cameras or other sensors that are produced as OEM products, obstruction awareness configurations define danger zones, and self-integrity awareness configurations include calibration updates. If an obstacle (e.g., a person or an object representing a person, a person's body part, or any other type obstacle) is located in or moving into a danger zone, the safety camera or sensor generates data indicative of the obstacle. Hardware, firmware, and/or software in the safety camera, the sensor, and/or the robot detect(s) the obstacle based on the data to stop the robot (or other system) from moving towards and hitting the object. As such, any obstruction in the danger zone is detected by the safety camera or other sensor which causes a stoppage or avoidance maneuver by the robot (or other system). For example, an obstruction awareness configuration can define a danger zone in terms of speed of motion (e.g., robot/system speed) and direction of travel (e.g., if the robot/system is turning left or right, the danger zone is adjusted to be in the direction of the turn). If the speed is higher, an obstruction awareness configuration can increase a size of the danger zone to be larger because it will take more time to stop (e.g., stopping distance is taken into account) a moving robot (or other system). In some examples, the process of determining the size and direction of a danger zone is performed by a system integrator (e.g., in a customer warehouse) based on, for example, different speeds and/or directions to be utilized by the robot (or other system).

Defining safety zones is done in the field (e.g., in a warehouse) and a silicon manufacturer of a SoC has no control over it. The defining of the safety zones can sometimes be performed using a safety design studio program that is used in the field and is involved in the signing of the safety zone configuration data to make sure the safety zone configuration data is authenticated before using it to update a robot. If someone were to hack into the safety camera (and/or its supporting control logic (e.g., hardware, firmware, and/or software)) and change the safety zone configuration data, examples disclosed herein can be used to detect such malicious change and prevent the robot from moving and may alert one or more of system management software, the system integrator, the system manufacturer, the OEM product manufacturer, and/or the silicon provider. In this manner, the system management software and/or one or more of these entities/parties can deactivate the robot and/or take any other corrective action to prevent a hazard based on this malicious action (e.g., through a denial of service).

For self-integrity awareness, safety cameras or other types of OEM products include hardware, firmware, and/or software to monitor OEM product integrity. The monitoring is to confirm that there is no failure that will prevent the OEM product from detecting a hazard. To maintain the integrity of an OEM product, a calibration of the OEM product is checked from time to time. For a safety camera, calibration parameters include intrinsic or internal parameters that allow mapping between pixel coordinates and camera coordinates in an image frame (e.g., optical center, focal length, and radial distortion coefficients of a lens (radial or tangential distortion)). Calibration parameters also include extrinsic or external parameters which describe the orientation and location of a safety camera (e.g., rotation and translation of the safety camera relative to some world coordinate system). If the calibration is not correct in, for example, a safety camera, a robot may determine an obstacle is further than it actually is and strike the obstacle. To prevent such instances, examples disclosed herein may be used to securely perform in-field updates of verified calibration data.

Some solutions to perform in-field configuration updates include the use of tools with password protections that sign configuration data and push the configuration data to flash memory products. Such solutions limit a product to self-sign the configuration data in an automatic calibration flow. Tools using user passwords have the problem that those passwords tend to leak or be shared between customers. As such, although password-based access control measures can be used to allow only authorized users to access sensitive configuration data, passwords stored in a product flash memory can potentially be leaked, shared, extracted from the product, etc. Another solution includes encrypting sensitive configuration data at rest and in transit using encryption algorithms. However, such encryption requires protecting access to keys in a tool used for setting sensitive configuration data as well in the product.

Examples disclosed herein preserve the integrity of in-field configuration updates to OEM products and/or their systems (e.g., to define danger zones and/or to update any other type of configuration information) by assuming a zero-trust environment and signing configuration data so that verification of the configuration data can be a prerequisite to performing an in-field update associated with an OEM product. In examples disclosed herein, verification of configuration data verifies that the configuration data has not been tampered with and/or that the configuration data is from an authorized source. In examples disclosed herein, verification of configuration data is based on signing keys, signed security certificates, and authenticity verification. As such, examples disclosed herein can be used to push product settings (e.g., calibration configuration data, safety configuration data, security configuration data, sensitive data, etc.) in-field by making those product settings protected from tampering and only allowed by trusted entities (e.g., OEM product manufacturers, system manufacturers, and system integrators) without the need to verify those trusted entities in-field. Accordingly, examples disclosed herein reduce post-production costs and efforts of silicon providers, manufacturing costs and efforts of OEM product manufacturers, and costs and efforts associated with performing in-field configuration updates.

Example signing and authentication flows disclosed herein to perform verification of configuration data combine keys saved in an OEM product (e.g., in a flash memory of an OEM product and/or in a one-time-programmable (OTP) memory of a SoC), secured settings (e.g., configuration data) protected in the OEM product's flash memory, authenticated certificates and keys stored in the OEM product's flash memory, and operations of a signing tool used in-the-field (e.g., zero trust) for an authorization process. Examples disclosed herein allow an OEM product to authorize a configuration update (e.g., related to safety, security, calibration, sensitive data, etc.) to be performed by a third party (e.g., an OEM product manufacturer, a system manufacturer, a system integrator, etc.) in an environment (e.g., a customer environment) separate from a silicon provider of an SoC. In addition, examples disclosed herein address security breaches by allowing for revocation of keys when it is determined that such keys have been compromised (e.g., leaked). The detection of compromised keys and revocation, as disclosed herein, improves security of configuration data over other systems that employ password-based access alone and/or key-based access alone because in those systems passwords and/or keys can be leaked or shared without the ability to detect such leaking or sharing.

Examples disclosed herein provide capabilities to securely perform “in-field” updates (e.g., performed by authorized third-parties at customer sites without intervention by silicon providers and/or OEM product manufacturers) by signing configuration settings including production-stage configuration settings developed by third parties outside of OEM product manufacturers and silicon providers. Examples disclosed herein can be implemented in a way that substantially reduces or eliminates the likelihood of exposing signing keys. In examples disclosed herein, even if signing keys are exposed for one OEM product instance, such security breach cannot be exploited for other OEM product installations. That is, if a security breach is used to attack one OEM product, examples disclosed herein keep the attack isolated to that one product without affecting other OEM products. As such, examples disclosed herein substantially reduce or eliminate the likelihood of physical attack.

Examples disclosed herein allow securely updating configuration data (e.g., calibration configuration data, safety configuration data, security configuration data, sensitive data, etc.) at in-field environments by third parties after OEM manufacturing of an OEM product that includes a SoC from a silicon provider. Examples disclosed herein assume such in-field environments to be zero-trust environments. As such, configuration updates cannot be protected during “secured boot” processes. Examples disclosed herein enable full control of signing keys, security certificates, and configuration data and provide high security (e.g., safety) which may be required for a safety certified product. Examples disclosed herein provide simplicity (e.g., for system manufacturers and/or system integrators) and useability of end-user configuration update processes. In addition, when a security breach is detected, examples disclosed herein can revoke and/or replace privileges. In example configuration data signing processes disclosed herein, updating of configuration data in OEM products and/or associated systems can be performed without relying on user passwords. In addition, as part of the disclosed configuration data signing processes, security certificates used in the signing processes are generated on a per-third-party basis. As such, examples disclosed herein prevent an un-authorized OEM manufacturer or other third party from signing configuration data for OEM products or associated systems.

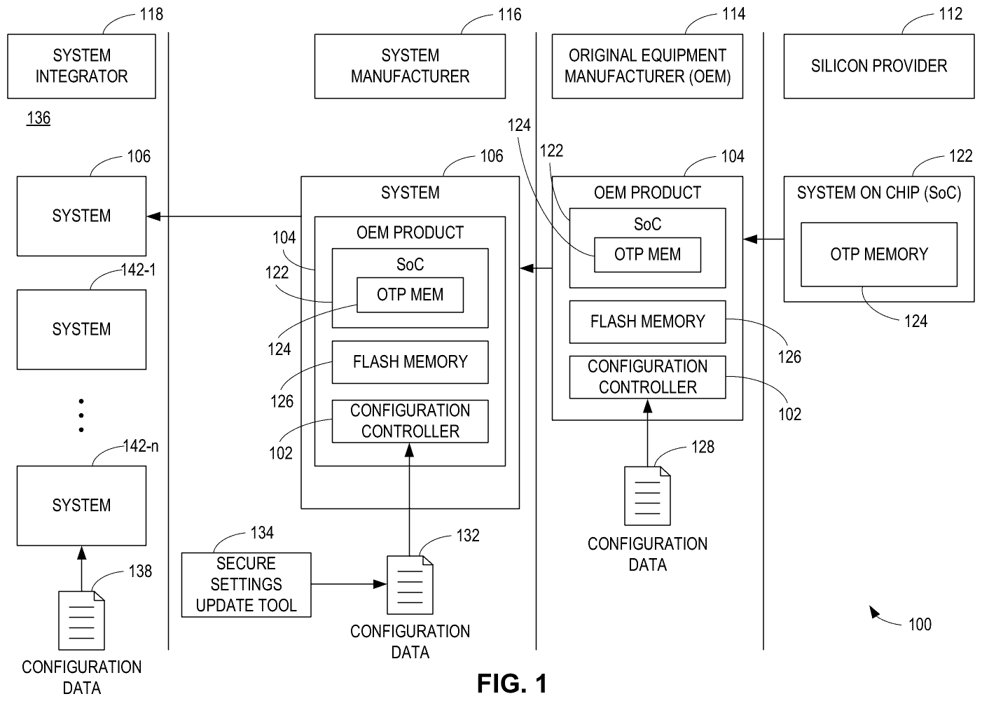

FIG. 1 is a block diagram of an example environment 100 in which an example configuration controller 102 of an example original equipment manufacturer (OEM) product 104 operates to securely perform configuration updates of the OEM product 104 and/or an example system 106 in which the OEM product 104 is incorporated. The environment 100 includes an example silicon provider 112, an example OEM 114, an example system manufacturer 116, and an example system integrator 118. In examples disclosed herein, the silicon provider 112 is a designer and/or manufacturer of semiconductor chips. In the example of FIG. 1, the silicon provider 112 provides an example system on chip (SoC) 122. The SoC 122 may be an imaging sensor chip, an audio sensor chip, a machine vision chip, a processor, a hardware accelerator, a storage chip, a memory chip, a transmitter, a receiver, and/or any other type of SoC. In the example of FIG. 1, the SoC 122 includes a one-time-programmable (OTP) memory 124.

In examples disclosed herein, the OEM 114 manufactures OEM products (e.g., safety cameras, sensors, electronic devices, electro-mechanical devices, etc.) such as the OEM product 104. For example, the OEM 114 obtains (e.g., purchases) a quantity of SoC's such as the SoC 122 from the silicon provider 112. The OEM 114 incorporates the SoC 122 into the OEM product 104. In addition, the OEM 114 incorporates the configuration controller 102 and an example flash memory 126 into the OEM product 104. An example OEM product that may be used in connection with examples disclosed herein is the Intel® RealSense™ Computer Vision-Depth and Tracking camera that is designed, manufactured, and sold by Intel Corporation of Santa Clara, California, United States of America.

In some examples, the configuration controller 102 is used by the OEM 114 to update the OEM product 104 with example configuration data 128 (e.g., calibration configuration data, safety configuration data, security configuration data, sensitive data, etc.). For example, the configuration data 128 may be developed by the OEM 114 for one or more aspects of the OEM product 104 and/or the SoC 122. In some examples, the OEM 114 is separate from the silicon provider 112. In other examples, the OEM 114 is the same entity as the silicon provider 112.

In the example of FIG. 1, the system manufacturer 116 obtains (e.g., purchases) the OEM product 104 from the OEM 114 and incorporates the OEM product 104 into the system 106. The system manufacturer 116 may be a robot manufacturer, a machine manufacturer, a computer manufacturer, a vehicle manufacturer, or a manufacturer of any other type of system. The system 106 may be any type of system including, for example, an industrial machine, a computer, a consumer electronic, a robot, an appliance, a vehicle, etc. In some examples, the configuration controller 102 performs an in-field configuration data update of the system 106, the OEM product 104, and/or the SoC 122 based on example configuration data 132. In the example of FIG. 1, the system manufacturer 116 receives an example secure settings update tool 134 as a software executable from the silicon provider 112 as part of a safety certified system. The example secure settings update tool 134 may be used by the system manufacturer 116 to develop production-stage configuration data (e.g., the configuration data 132) which is specific to characteristics and/or uses of the system 106.

The system integrator 118 obtains (e.g., purchases) the system 106 and integrates the system 106 into an end-user environment 136 (e.g., a warehouse environment, a manufacturing environment, a distribution center, a retail environment, etc.). In some examples, the system integrator 118 obtains multiple systems 142-1 through 142-n substantially similar or identical to the system 106 from the system manufacturer 116 for installation at the end-user environment 136. During such installation, and/or any time thereafter, the system 106 may perform an in-field update based on example configuration data 138. For example, the system integrator 118 may obtain a secure settings update tool (e.g., substantially similar or identical to the secure settings update tool 134) from the silicon provider 112 to develop production-stage configuration data (e.g., the configuration data 138) which is specific to characteristics and/or uses of the system 106 in the end-user environment 136.

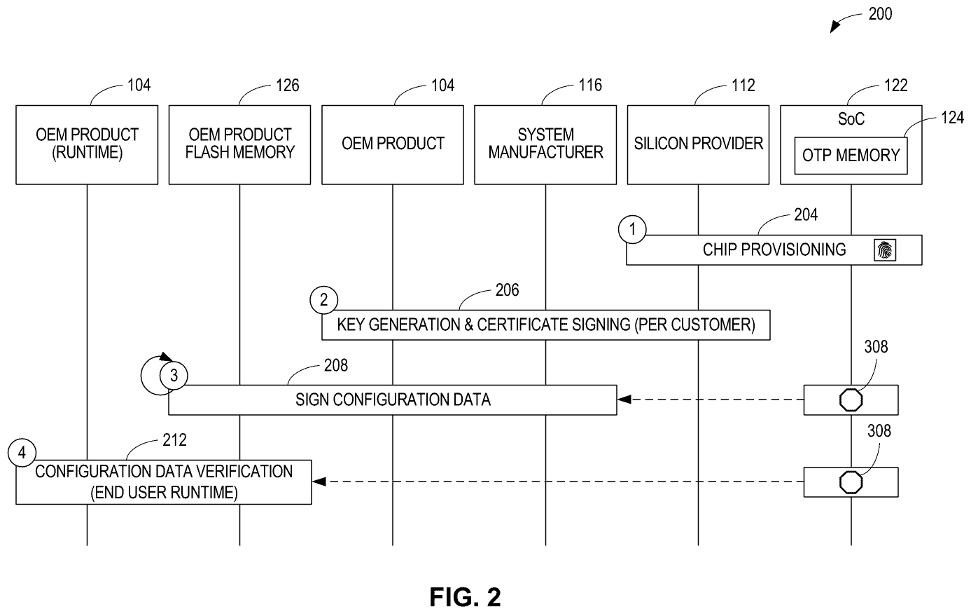

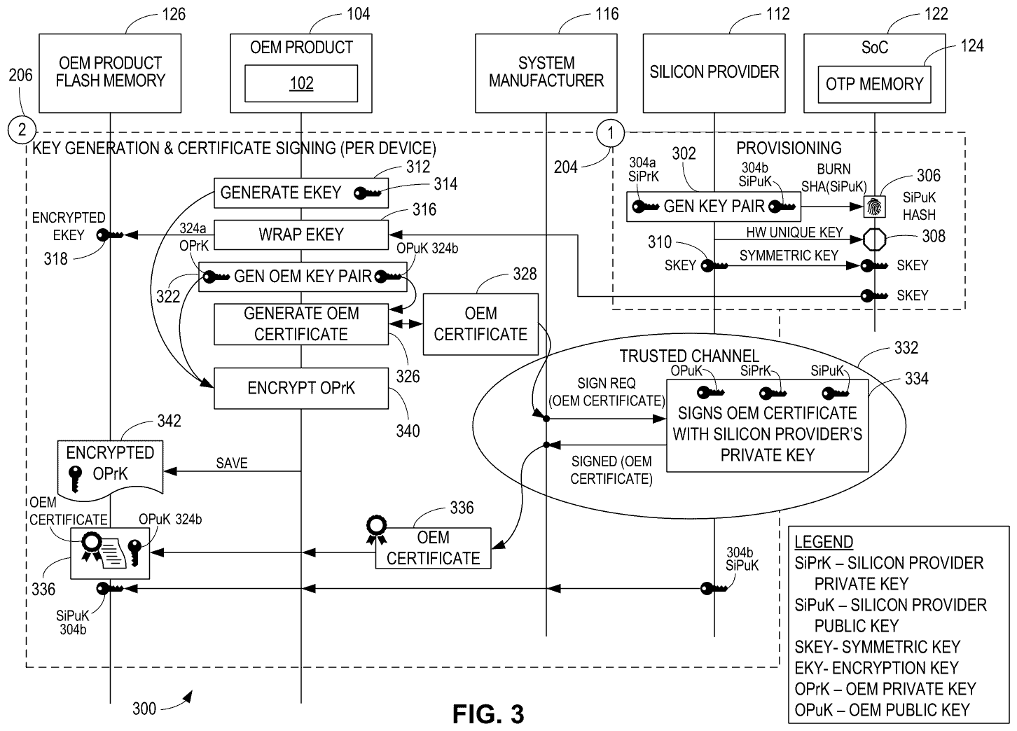

FIG. 2 is an example process flow diagram 200 to provision the SoC 122, create a signature of an OEM certificate, sign configuration data, and use the signed configuration data. The process flow diagram 200 includes an example chip provisioning phase 204 in which the silicon provider 112 provisions the SoC 122. For example, the silicon provider 112 provisions the SoC 122 by adding cryptographic information to the OTP memory 124 of the SoC 122 as described below in connection with FIG. 3. The process flow diagram 200 also includes an example generation and certificate signing phase 206. The generation and certificate signing phase 206 occurs during a manufacturing phase of the system manufacturer 116 in which the system manufacturer 116 generates signing keys and a security certificate, as described below in connection with FIG. 3, to support in-field configuration data updates. In examples disclosed herein, the system manufacturer 116 is an entity authorized to generate configuration data. In examples disclosed herein, the OEM 114 generates specific signing keys for each such authorized entity (e.g., the system manufacturer 116, other system manufacturers, the system integrator 118, other system integrators, end-user customers, etc.).

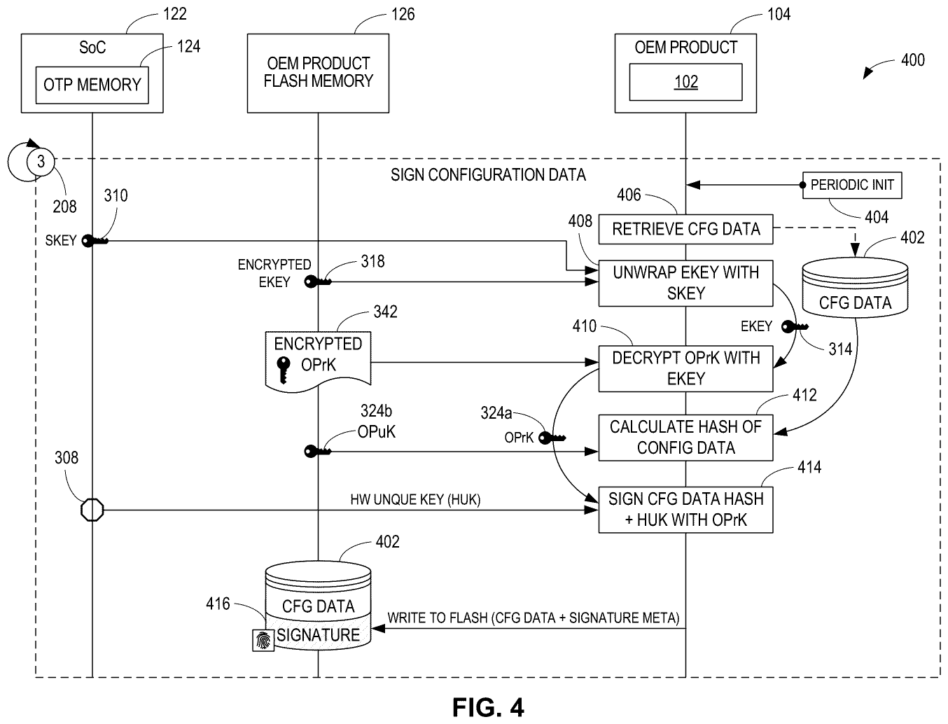

The process flow diagram 200 also includes an example sign configuration data phase 208 (e.g., a configuration data signature phase) in which the system manufacturer 116 signs configuration data (e.g., the configuration data 132 of FIG. 1) as described below in connection with FIG. 4. In the sign configuration data phase 208, different authorized entities (e.g., the system manufacturer 116, other system manufacturers, the system integrator 118, other system integrators, end-user customers, etc.) can use their corresponding signing keys to sign configuration data to be updated in-field in systems and/or OEM products through their exposed application programming interfaces (APIs). In some examples, an OEM product (e.g., the OEM product 104) can be an authorized entity itself. In such examples, as an authorized entity, the OEM product 104 can perform self-calibration and can sign self-calibration configuration data using an internally provisioned security certificate.

The process flow diagram 200 also includes an example configuration data verification and update phase 212 in which the OEM product 104 verifies configuration data and performs an update based on the verified configuration data during runtime of the OEM product 104. For example, the OEM product 104 verifies a signature of signed configuration data and only if a match is verified does the OEM product 104 perform an update based on the configuration data and log the signer. In examples disclosed herein, the OEM product 104 performs the same verification process on the signed configuration data on every usage of that configuration data. In some examples, during runtime of the OEM product 104, the OEM product 104 derives configuration data, signs the configuration data, and verifies the signed configuration data during a configuration data update (e.g., to generate and use self-calibration settings).

Each of the chip provisioning phase 204, the generation and certificate signing phase 206, the sign configuration data phase 208, and the configuration data verification and update phase 212 are described in greater detail below. The phases 204, 206, 208, 212 enable the silicon provider 112, the OEM 114, the system manufacturer 116, and the system integrator 118 to be detached from one another and still provide secure configuration updates to the OEM product 104 and/or the system 106. As described below, the system manufacturer 116 is responsible for its own signing keys, and from that point on, the silicon provider 112 has its own signing keys to authenticate configuration data but is not directly involved in configuration data update processes. For example, the silicon provider 112 is not involved in the sign configuration data phase 208 or the configuration data verification and update phase 212. In addition, if the system manufacturer 116 fails to keep its signing keys secret and protected, and they are leaked, the silicon provider 112 has the ability to revoke the compromised signing keys of the system manufacturer 116 through a software update.

FIG. 3 is an example process flow diagram 300 to generate signing keys at the OEM product 104 of FIGS. 1 and 2 and sign an OEM security certificate. FIG. 3 includes the example chip provisioning phase 204 of FIG. 2 and the example generation and certificate signing phase 206 of FIG. 2 as part of onboarding of the system manufacturer 116. In the chip provisioning phase 204, the silicon provider 112 generates a silicon provider asymmetric key-pair at block 302. The silicon provider key-pair includes an example silicon provider private key (SiPrK) 304a and an example silicon provider public key (SiPuK) 304b. The silicon provider 112 generates a hash of the SiPuK 304b shown as an example SiPuK hash 306 in FIG. 3. The silicon provider 112 burns the SiPuK hash 306 in the OTP memory 124 (FIG. 1) of the SoC 122 and keeps the SiPrK 304a as a secret (e.g., does not burn the SiPrK 304a in the OTP memory 124).

In some examples, the silicon provider 112 generates a plurality of silicon provider asymmetric key-pairs at block 302. For example, the silicon provider 112 can generate a list of silicon provider asymmetric key-pairs indexed as silicon provider asymmetric key-pairs 1 through m (e.g., (SiPrK1, SiPuK1); (SiPrK2, SiPuK2); (SiPrK3, SiPuK3); . . . ; (SiPrKm, SiPuKm)). The multiple key-pairs can be used as backup pairs for use in the event that a primary active key-pair becomes compromised (e.g., leaked, accessed by an unauthorized party, etc.) and subsequently revoked. In some examples, some of the multiple key-pairs can be used for different OEMs. For example, a first set of 20 silicon provider asymmetric key-pairs could be created for a first OEM, a second set of 20 silicon provider asymmetric key-pairs could be created for a second OEM, and a third set of 20 silicon provider asymmetric key-pairs could be created for a third OEM. When the silicon provider 112 creates multiple silicon provider asymmetric key-pairs (whether they be for a single OEM or multiple OEMs), the silicon provider 112 generates hashes for all of the silicon provider public keys (SiPuKs) and stores the SiPuK hashes in the OTP memory 124 in a manner substantially similar or identical to how the SiPuK hash 306 is stored in the OTP memory 124. Accordingly, if a first silicon provider asymmetric key-pair that is indexed in the list of silicon provider asymmetric key-pairs (e.g., 1-m) is compromised and subsequently revoked, a next silicon provider asymmetric key-pair is used as the active silicon provider asymmetric key-pair along with its corresponding SiPuK hash in the OTP memory 124.

Also in the chip provisioning phase 204, the silicon provider 112 generates an example hardware unique key (HUK) 308 (e.g., a hardware universally unique identifier (UUID)) and an example symmetric key (SKEY) 310. The silicon provider 112 burns the HUK 308 and the SKEY 310 in the OTP memory 124 of the SoC 122. Both the HUK 308 and the SKEY 310 are unique to the SoC 122. After the provisioning of the SoC 122 is complete, the silicon provider 112 locks the SoC 122 so that the OTP memory 124 is not modifiable by another party. At this point, the SoC 122 is ready to be provided (e.g., sold, shipped, etc.) to an authorized entity such as the OEM 114 (FIG. 1) so that the OEM 114 can incorporate the SoC 122 into the OEM product 104.

The example generation and certificate signing phase 206 shown in FIG. 3 takes place after the OEM 114 has incorporated the SoC 122 into the OEM product 104 and provided the OEM product 104 to the system manufacturer 116. In the generation and certificate signing phase 206, the system manufacturer 116 is an entity that is separate from the silicon provider 112 but works with the silicon provider 112 to bind the OEM product 104 to the SoC 122. However, because the generation and certificate signing phase 206 is performed within a chain of trust (e.g., the trusted channel 332), the generation and certificate signing phase 206 can additionally or alternatively be performed by the OEM 104 in substantially the same way as described below.

At block 312, the system manufacturer 116 causes the configuration controller 102 of the OEM product 104 to generate an example symmetric encryption key (EKEY) 314. In examples disclosed herein, the EKEY 314 is unique to the system manufacturer 116. In some examples, the configuration controller 102 generates the EKEY 314 based on a password that is registered for use in accessing the OEM product 104. Each separate authorized entity (e.g., other system manufacturers) generates its own unique symmetric encryption key for use with its OEM products. At block 316, the configuration controller 102 wraps or encrypts the EKEY 314 based on the SKEY 310 from the OTP memory 124 of the SoC 122 to generate an encrypted EKEY 318. The configuration controller 102 stores the encrypted EKEY 318 in the flash memory 126 of the OEM product 104. In examples disclosed herein, the EKEY 314 is saved as the encrypted EKEY 318 because the flash memory 126 is not considered a safe area to store secrets.

At block 322, the system manufacturer 116 causes the configuration controller 102 to generate an OEM asymmetric key-pair which includes an example OEM private key (OPrK) 324a and an example OEM public key (OPuK) 324b. The OPrK 324a and the OPuK 324b are different from the SiPrK 304a and the SiPuK 304b of the silicon provider 112 generated in the chip provisioning phase 204. In addition, the OPrK 324a and the OPuK 324b are generated at the system manufacturer 116 so that the OPrK 324a and the OPuK 324b are shielded from being known by the silicon provider 112. The system manufacturer 116 remains in control and possession of its own OPrK 324a and OPuK 324b.

In some examples, the OPrK 324a and the OPuK 324b are generated per product grouping (e.g., per product model, per product quantities, etc.). For example, products of a particular product model may use the same first OEM asymmetric key-pair (e.g., the OPrK 324a and the OPuK 324b) that is different from a second OEM asymmetric key-pair of another product model. Alternatively, two production lots of the same product model may be assigned two different OEM asymmetric key-pairs. For example, for the same product model, a first OEM asymmetric key-pair (e.g., the OPrK 324a and the OPuK 324b) may be generated for use with a first quantity of products in a first production lot (e.g., products 1 through 1000), and a different, second OEM asymmetric key-pair may be generated for use with a second production lot of a second quantity of products (e.g., products 1001 through 2000).

At block 326, the configuration controller 102 generates an OEM security certificate 328 (e.g., an X.509 certificate according to the International Telecommunications Union (ITU) X.509 standard) based on the OPuK 324b. The configuration controller 102 causes the OEM product 104 to send the OEM certificate 328 to the silicon provider 112 via an example trusted channel 332 along with a request for the silicon provider 112 to sign the OEM certificate 328. At block 334, the silicon provider 112 signs the OEM certificate 328 with the SiPrK 304a to generate an example signed OEM certificate 336 and returns the signed OEM certificate 336 to the system manufacturer 116. Based on this signing to generate the signed OEM certificate 336, the silicon provider 112 binds its SiPrK 304a and SiPuK 304b to the SoC 122 in the OEM product 104. In examples disclosed herein, this signing of the OEM certificate 328 to generate the signed OEM certificate 336 happens only once for the OEM certificate 328.

The silicon provider 112 also sends the SiPuK 304b to the system manufacturer 116. The system manufacturer 116 provides the signed OEM certificate 336 and the SiPuK 304b to the OEM product 104. The configuration controller 102 of the OEM product 104 stores the signed OEM certificate 336, the OPuK 324b, and the SiPuK 304b in the flash memory 126 of the OEM product 104. For example, the signed OEM certificate 336, the OPuK 324b, and the SiPuK 304b can be stored once in the flash memory 126 and subsequently used one or more times to sign and/or verify configuration data as described below.

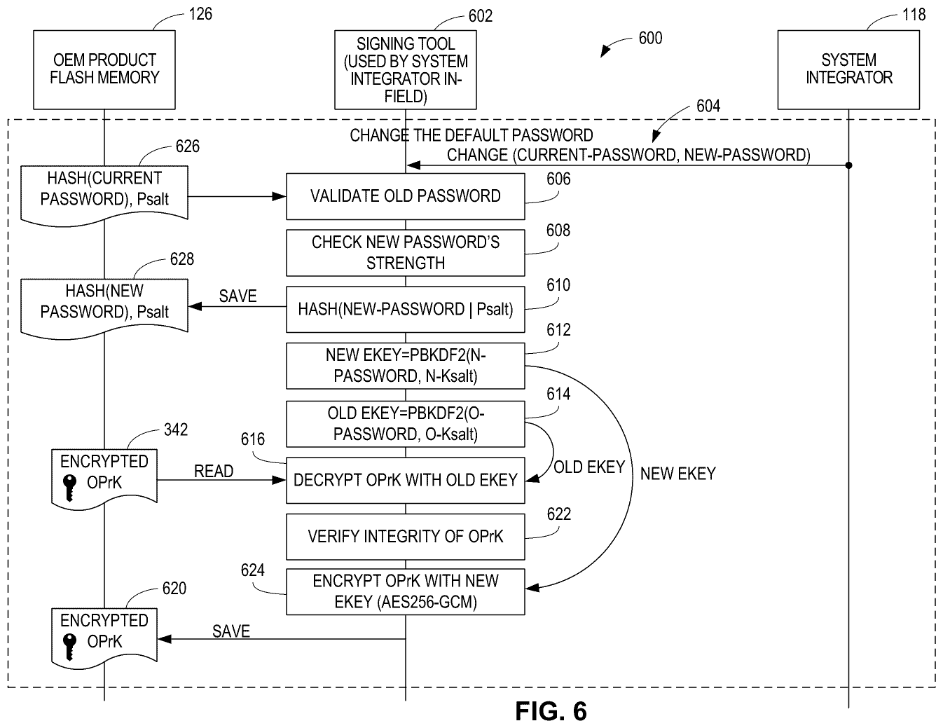

At block 340, the configuration controller 102 encrypts the OPrK 324a based on the symmetric EKEY 314 to generate an example encrypted OPrK 342 and stores the encrypted OPrK 342 in the flash memory 126 of the OEM product 104. In some examples, the configuration controller 102 encrypts the OPrK 324a based on an Advanced Encryption Standard (AES) 256 in Galois/Counter Mode (GCM) (AES256-GCM) encryption standard. In other examples, any other suitable encryption standard may be used. Completion of the key generation and certificate signing phase 206 enables the system manufacturer 116 to sign subsequent configuration data without future dependence or reliance on the silicon provider 112 to do so. In some examples, the configuration controller 102 generates a message authentication code (MAC) of the OEM product 104 based on the EKEY 314 and stores the MAC with the encrypted OPrK 342. In some examples, the configuration controller 102 also stores a salt with the MAC and the encrypted OPrK 342 to increase the strength of integrity verification for the OPrK 324a (e.g., the integrity verification at block 622 of FIG. 6).

FIG. 4 is an example process flow diagram 400 in which the OEM product 104 of FIGS. 1-3 self-signs example configuration data 402 as part of the sign configuration data phase 208 (e.g., a configuration data signature phase) of FIG. 2. The configuration data 402 may be, for example, calibration configuration data, safety configuration data, security configuration data, and/or any other sensitive data to be protected. The configuration data 402 is an input to the process flow diagram 400 after it is generated by a third party to suit purposes of the third party and/or a customer. For example, the configuration data 402 may be provided by the system manufacturer 116 (FIGS. 1 and 2) that incorporates the OEM product 104 into the system 106 or by the system integrator 118 (FIG. 1) that integrates the system 106 into a customer solution.

In the example of FIG. 4, the OEM product 104 self-signs the configuration data 402 so that the integrity of the configuration data 402 can be subsequently verified when the OEM product 104 performs an update based on the configuration data 402. In the example of FIG. 4, the OEM product 104 is involved in the signing. However, because of the key generation and certificate signing phase 206 described above in connection with FIG. 3, the signing of the configuration data 402 in the sign configuration data phase 208 can be done without involvement by the silicon provider 112 and/or without human involvement or human intervention.

At block 404, the configuration controller 102 of the OEM product 104 periodically or on demand initializes a check for new configuration data. The configuration controller 102 does this so that it can save the configuration data 402 in the flash memory 126 of the OEM product 104 as singed configuration data so that the integrity of the configuration data 402 is protected from tampering by attackers.

At block 406, the configuration controller 102 retrieves or accesses the configuration data 402. At block 408, the configuration controller 102 unwraps or decrypts the encrypted EKEY 318 from the flash memory 126 based on the SKEY 310 from the OTP memory 124 of the SoC 122 to recover the EKEY 314. At block 410, the configuration controller 102 decrypts the encrypted OPrK 342 from the flash memory 126 based on the EKEY 314 to recover the OPrK 324a. At block 412, the configuration controller 102 calculates a hash of the configuration data 402 based on the OPuK 324b from the flash memory 126. At block 414, the configuration controller 102 concatenates (i) the configuration data hash and (ii) the HUK 308 from the OTP memory 124 and signs the concatenation based on the OPrK 324a.

The configuration controller 102 writes the configuration data 402 and the corresponding signature metadata 416 to the flash memory 126. In the illustrated example, the signature metadata 416 includes the signature of the concatenated configuration data hash and the HUK 308.

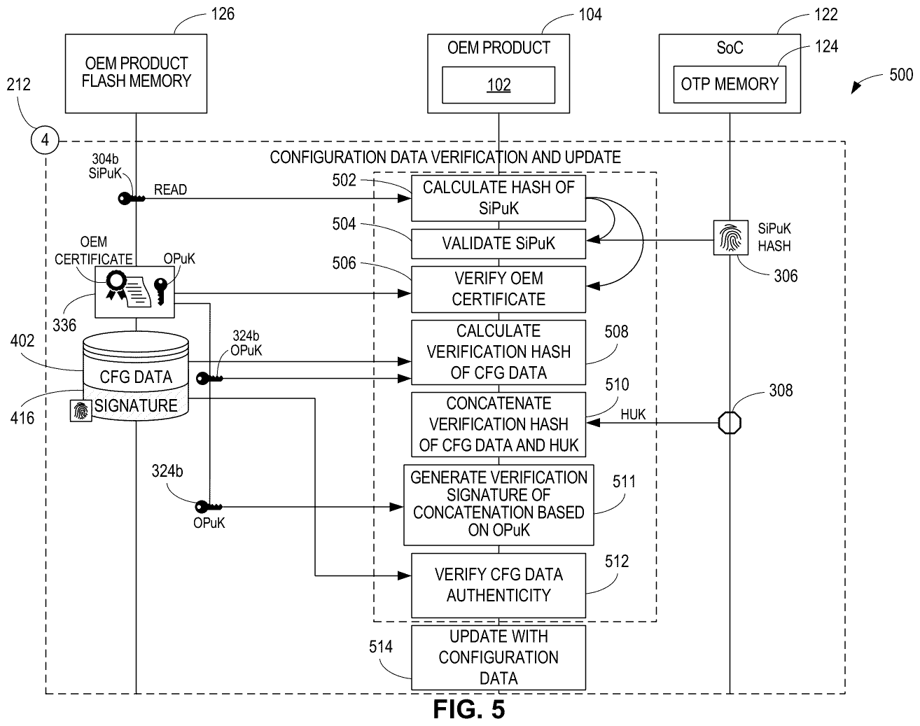

FIG. 5 is an example process flow diagram 500 to verify the configuration data 402 based on the signature metadata 416 and use the configuration data 402 as part of the configuration data verification and update phase 212 of FIG. 2. In the example of FIG. 5, the configuration data verification and update phase 212 occurs during a runtime of the OEM product 104 at in-field environments for in-field configuration data updates. At block 502, the configuration controller 102 of the OEM product 104 calculates a hash of the SiPuK 304b from the flash memory 126. For example, the configuration controller 102 can calculate the hash using the SHA512 encryption standard or any other suitable encryption standard.

At block 504, the configuration controller 102 validates the SiPuK 304b by comparing the hash of the SiPuK 304b generated at block 502 to the SiPuK hash 306 in the OTP memory 124 of the SoC 122. The configuration controller 102 validates the SiPuK 304b from the flash memory 126 in this manner because the flash memory 126 is not considered a safe place to store secrets. As such, the validation of the SiPuK 304b is performed at block 504 to confirm that the SiPuK 304b has not been compromised (e.g., tampered with, modified, replaced, etc.) in the flash memory 126. At block 506, the configuration controller 102 verifies the OEM certificate 328 (FIG. 3) based on the SiPuK 304b and the signed OEM certificate 336 from the flash memory 126. In the illustrated example of FIG. 5, the verifying of the OEM certificate 328 at block 506 serves to verify the integrity of the OPuK 324b.

At blocks 508, 510, 511, and 512, the configuration controller 102 performs an authenticity verification process of the configuration data 402 based on the OPuK 324b. At block 508, the configuration controller 102 calculates a verification hash of the configuration data 402 from the flash memory 126 based on the OPuK 324b from the flash memory 126. The configuration controller 102 may calculate the hash using a SHA standard or any other suitable standard.

At block 510, the configuration controller 102 concatenates (i) the verification hash of the configuration data 402 generated at block 508 with (ii) the HUK 308 from the OTP memory 124 of the SoC 122. The HUK 308 is used at block 510 in preparation to verify the authenticity of the configuration data 402 to confirm that an HUK of another SoC was not used to sign the configuration data 402. Such use of another HUK could compromise the SoC 122 and/or its associated system 106.

At block 511, the configuration controller 102 generates a verification signature of the concatenation of block 510 based on the OPuK 324b. Since the OPuK 324b is paired with the OPrK 324a and the OPrK 324a was used to sign the OEM certificate 328 at block 334 of FIG. 3, the OPuK 324b is part of the signed OEM certificate 336 in the flash memory 126. As such, the configuration controller 102 can retrieve the OPuK 324b from the flash memory 126 for use at block 511.

At block 512, the configuration controller 102 verifies the authenticity of the configuration data 402. For example, the configuration controller 102 compares the verification signature of block 511 with the configuration data signature in the signature metadata 416 from the flash memory 126 to verify the authenticity of the configuration data 402. A match between the verification signature of block 511 and the configuration data signature in the signature metadata 416 confirms verification of the configuration data 402. Alternatively, a verification failure is confirmed when there is a non-match between the verification signature of block 511 and the configuration data signature in the signature metadata 416.

After successful validation of the SiPuK 304b at block 504, verification of the OEM certificate 328 at block 506, and verification of the authenticity of the configuration data 402 at block 512, the configuration controller 102 updates the OEM product 104 and/or the associated system 106 (FIG. 1) based on the configuration data 402 at block 514. If any of the SiPuK 304b, the OEM certificate 328, and/or the configuration data 402 is not verified or validated, the configuration controller 102 revokes (e.g., overrides) the signed OEM certificate 336, thereby rejecting or revoking (e.g., a denial of service) the SiPuK 304b (and the SiPrK 304a), the OEM certificate 328, and the configuration data 402. That is, if an intruder copies the configuration data 402 from the flash memory 126 and obtains an imposter signature that does not belong to the OEM product 104, this will break the verification/validation of the SiPuK 304b, the OEM certificate 328, and/or the configuration data 402 because the imposter signature is not using the HUK 308 that is specific to the OEM product 104.

As described above in connection with blocks 414 and 512, the HUK 308 is part of the signature (e.g., the signature metadata 416) of the configuration data 402. Therefore, the configuration data 402 and its signature metadata 416 are specific to the OEM product 104. As such, if the configuration data 402 and the corresponding signature metadata 416 are taken to another OEM product that does not have the same HUK 308, a configuration update based on the configuration data 402 will be denied at that other OEM product. Such denial provides another layer of protection to securely perform updates based on the configuration data 402. In the event that the configuration controller 102 revokes compromised signing keys and a compromised OEM certificate, new signing keys and a new OEM certificate can be generated for the OEM product 104 via a software update (e.g., by updating the firmware or the flash memory 126 of the OEM product 104) so that previously certified signing keys will no longer pass authentication with the new OEM certificate. As described above in connection with FIG. 3, the silicon provider 112 can generate multiple silicon provider key-pairs (e.g., (SiPrK1, SiPuK1); (SiPrK2, SiPuK2); (SiPrK3, SiPuK3); . . . ; (SiPrKm, SiPuKm)) that can be used as backup pairs for use in the event that a primary active silicon provider key-pair becomes compromised (e.g., leaked, accessed by an unauthorized party, etc.) and subsequently revoked. As such, a software update after such a revocation of signing keys can deactivate the compromised signing keys and the corresponding SiPuK hash 306. In addition, the software update can enable a backup silicon provider key-pair and a corresponding backup SiPuK hash (e.g., a backup SiPuK hash that is a backup for the SiPuK hash 306) as the active silicon provider key-pair and the corresponding active SiPuK hash.

FIG. 6 is an example process flow diagram 600 to change a default password for the OEM product 104 of FIGS. 1-5 using an example signing tool 602. In examples disclosed herein, the signing tool 602 is used by the system integrator 118 (FIG. 1) for in-field configuration data updates. In some examples, the signing tool 602 implements or is part of the secure settings update tool 134 of FIG. 1. In some examples, the system integrator 118 uses the signing tool 602 to sign safety configuration data (e.g., the configuration data 402 of FIGS. 4 and 5) that define safety zones for a robot installed on a customer premises (e.g., a warehouse, a distribution center, a manufacturing environment, etc.). In other examples, the system integrator 118 uses the signing tool 602 to sign any other type of configuration data and/or for any other type of system.

The process flow diagram 600 begins when the signing tool 602 receives a password change request 604 from the system integrator 118. For example, the system integrator 118 may choose to change a current default password with a new (e.g., unique) password. At block 606, the signing tool 602 validates the old password. In the example of FIG. 6, the old password is referred to as the current password. As such, the signing tool 602 obtains a hash of the current password 626 from the flash memory 126 to perform the old-password validation of block 606. In some examples, a salt (e.g., a Psalt) may be used as an input to the hash process of the current password 626 (e.g., the Psalt can be concatenated with the current password 626) to create a unique hash of the current password 626. At block 608, the signing tool 602 checks the strength of the new password. For example, the signing tool 602 may include one or more rules (e.g., password length, number of numeric characters, number of capital letters, number of symbol characters, etc.) that are to be satisfied by a new password before the new password is committed as the current password for the OEM product 104.

At block 610, the signing tool 602 concatenates the new password with a Psalt value, calculates a password hash 628 of the concatenation, and stores the password hash 628 of the concatenation of the new password and the Psalt value in the flash memory 126. At block 612, the signing tool 602 generates a new EKEY based on a Password Based Key Derivation Function 2 (PBKDF2) of the new password (N-password) and a new Ksalt (N-Ksalt) (e.g., new EKEY=PBKDF2(N-password, N-Ksalt).

At block 614, the signing tool 602 generates the old EKEY (e.g., the EKEY 314 of FIG. 3) based on a PBKDF2 function of the old password and an old Ksalt (e.g., old EKEY=PBKDF2(O-password, O-Ksalt). At block 616, the signing tool 602 decrypts the encrypted OPrK 342 to recover the OPrK 324a using the old EKEY from block 616. For example, the signing tool 602 can decrypt the encrypted OPrK 342 based on the AES256-GCM standard or any other suitable standard.

At block 622, the signing tool 602 verifies the integrity of the OPrK 324a based on the OPrK 324a decrypted at block 614. In some examples, the signing tool 602 verifies the integrity of the OPrK 324a by verifying a message authentication code (MAC) of the OEM product 104 stored with the encrypted OPrK 342 in the flash memory 126. For example, the MAC of the OEM product 104 can be generated based on the old EKEY (e.g., the EKEY 314 of FIG. 3) that was generated using an old password. When the password is changed to the new password (N-password), a new MAC is generated using the new EKEY from block 612 and stored with a new encrypted OPrK 620 generated at block 624. In some examples, the new Ksalt (N-Ksalt) is stored with the new encrypted OPrK 620 and the new MAC to increase the strength of the integrity of the new OPrK that is encrypted as the new encrypted OPrK 620.

At block 624, the signing tool 602 encrypts the OPrK 324a based on the new EKEY to generate the new encrypted OPrK 620. For example, the signing tool 602 can encrypt the OPrK 324a based on the AES256-GCM standard or any other suitable standard. The signing tool 602 stores the new encrypted OPrK 620 in the flash memory 126.

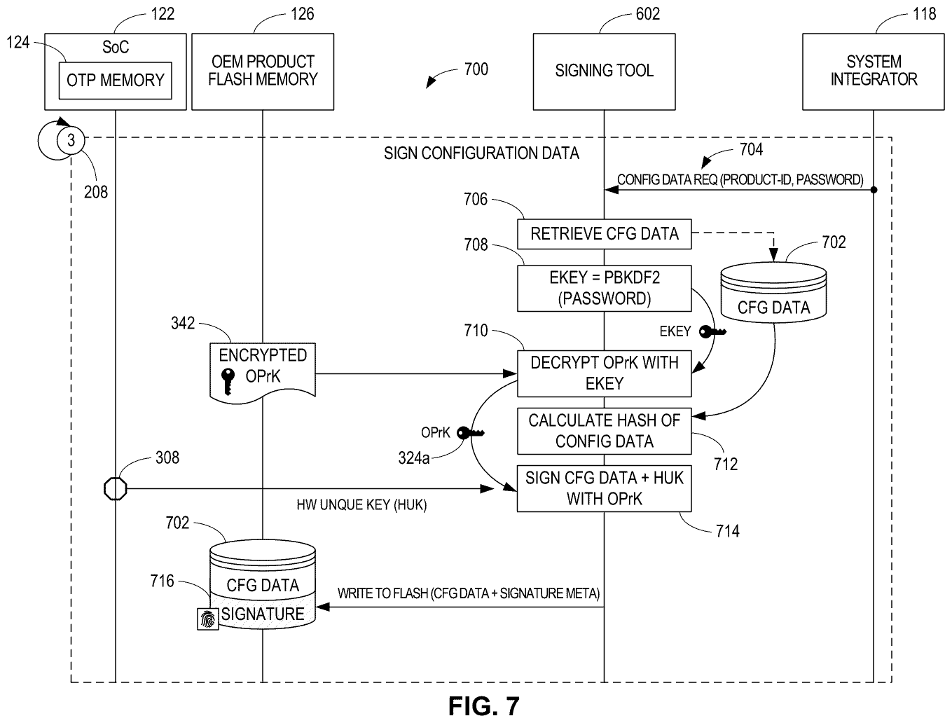

FIG. 7 is an example process flow diagram 700 in which the signing tool 602 of FIG. 6 signs example configuration data 702 for the OEM product of FIGS. 1-5. In some examples, the process flow diagram 700 can implement the sign configuration data phase 208 (e.g., a configuration data signature phase) of FIG. 2. The configuration data 702 can be substantially similar or identical to the configuration data 402 of FIG. 4. The configuration data 702 is an input to the process flow diagram 700 after it is generated by a third party (e.g., the system manufacturer 116 (FIGS. 1 and 2), the system integrator 118 (FIG. 1), etc.) to suit purposes of the third party and/or a customer. Unlike the example of FIG. 4 in which the OEM product 104 self-signs the configuration data 402, in the example of FIG. 7, the signing tool 602 signs the configuration data 702. Based on this signing, the integrity of the configuration data 702 can be subsequently verified when the OEM product 104 performs an update based on the configuration data 402 (e.g., as described above in connection with FIG. 5). In the example of FIG. 7, the signing of the configuration data 702 can be done without involvement by the silicon provider 112 and/or without human involvement or human intervention.

The process flow diagram 700 begins when the signing tool 602 receives an example configuration data request 704 from a third party such as the system integrator 118. In the example of FIG. 7, the configuration data request 704 includes login credentials in the form of a product-ID and a password. For example, the password can be the new password of FIG. 6. To proceed with the remainder of the process, the signing tool 602 confirms that the login credentials verify against the password hash 628 (FIG. 6) which is salted and stored in the flash memory 126.

At block 706, the signing tool 602 retrieves or accesses the configuration data 702. At block 708, the signing tool 602 determines the EKEY based on a PBKDF2 function of the password. At block 710, the signing tool 602 decrypts the encrypted OPrK 342 from the flash memory 126 based on the EKEY from block 708 to recover the OPrK 324a. At block 712, the signing tool 602 calculates a hash of the configuration data 702. At block 714, the signing tool 602 concatenates (i) the configuration data hash and (ii) the HUK 308 from the OTP memory 124 and signs the concatenation based on the OPrK 324a.

The signing tool 602 writes the configuration data 702 and the corresponding signature metadata 716 to the flash memory 126. In the illustrated example, the signature metadata 716 includes the signature of the concatenated configuration data hash and the HUK 308. Subsequently, the OEM product 104 can verify the configuration data 702 and perform an update based on the configuration data 702 using the configuration data verification and update phase 212 of FIG. 5.

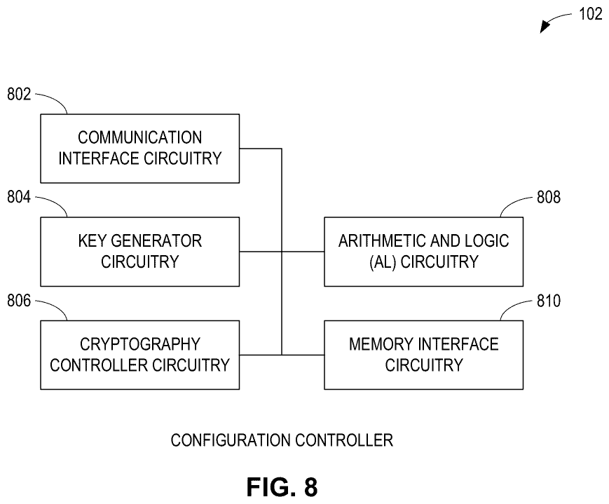

FIG. 8 is a block diagram of an example implementation of the configuration controller 102 of FIG. 1 to generate the OPrK 324a, the OPuK 324b, and the OEM certificate 328 of FIG. 3, to obtain the signed OEM certificate 336 of FIG. 3, and to verify configuration data and perform updates based on the verified configuration data. Additionally or alternatively, one or more of the blocks illustrated in FIG. 8 may be used to implement the singing tool 602 to sign configuration data as described above in connection with FIG. 7. The configuration controller 102 of FIG. 8 may be instantiated (e.g., creating an instance of, bring into being for any length of time, materialize, implement, etc.) by programmable circuitry such as a Central Processor Unit (CPU) executing first instructions. Additionally or alternatively, the configuration controller 102 of FIG. 8 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 8 may, thus, be instantiated at the same or different times. Some or all of the circuitry of FIG. 8 may be instantiated, for example, in one or more threads executing concurrently on hardware and/or in series on hardware. Moreover, in some examples, some or all of the circuitry of FIG. 8 may be implemented by microprocessor circuitry executing instructions and/or FPGA circuitry performing operations to implement one or more virtual machines and/or containers.

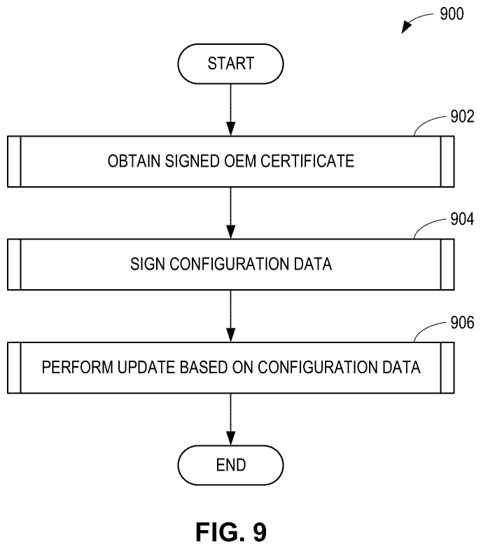

In the example of FIG. 8, the configuration controller 102 includes example communication interface circuitry 802, example key generator circuitry 804, example cryptography controller circuitry 806, example arithmetic and logic (AL) circuitry 808, and example memory interface circuitry 810. The communication interface circuitry 802 is provided to communicate with devices, systems, and/or entities external to the OEM product 104. For example, the communication interface circuitry 802 can communicate with the OEM product 104 and/or computer systems of the silicon provider 112, the OEM 114, the system manufacturer 116, and/or the system integrator 118. The communication interface circuitry 802 may be implemented using any suitable wired or wireless communication interface. In some examples, the communication interface circuitry 802 is instantiated by programmable circuitry executing communication interface instructions and/or configured to perform operations such as those represented by the flowcharts of FIGS. 9-12.

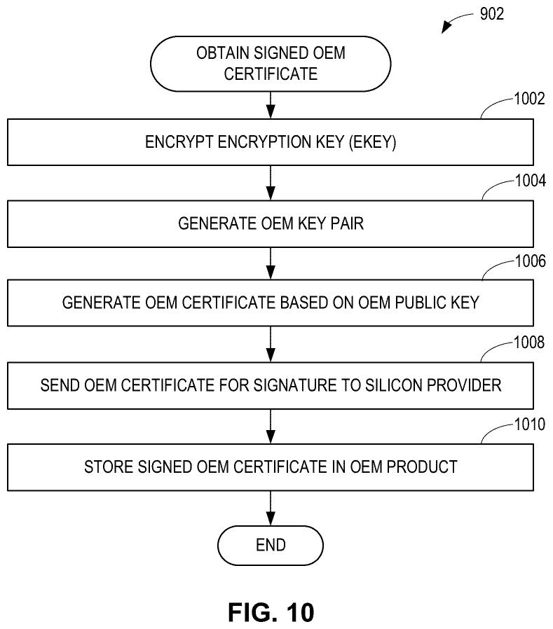

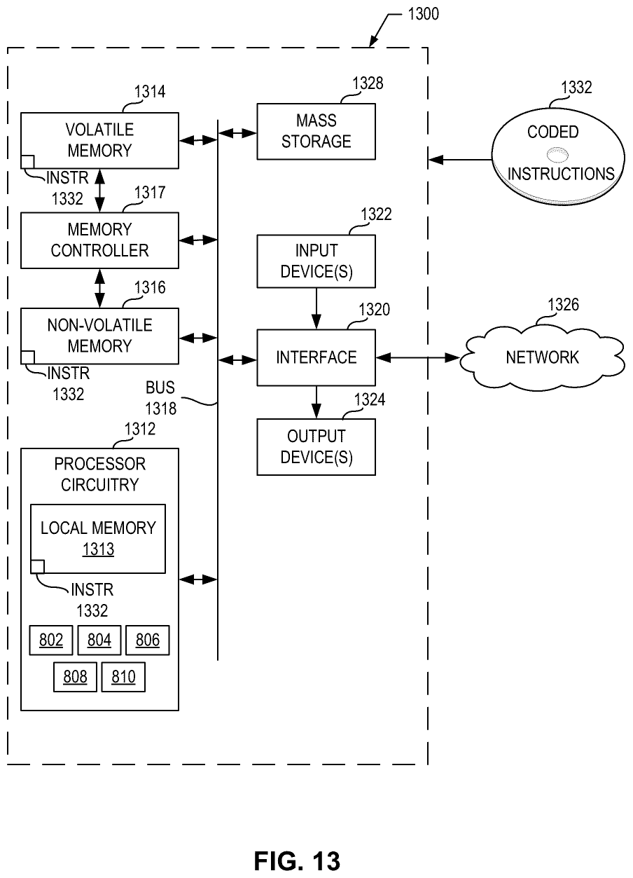

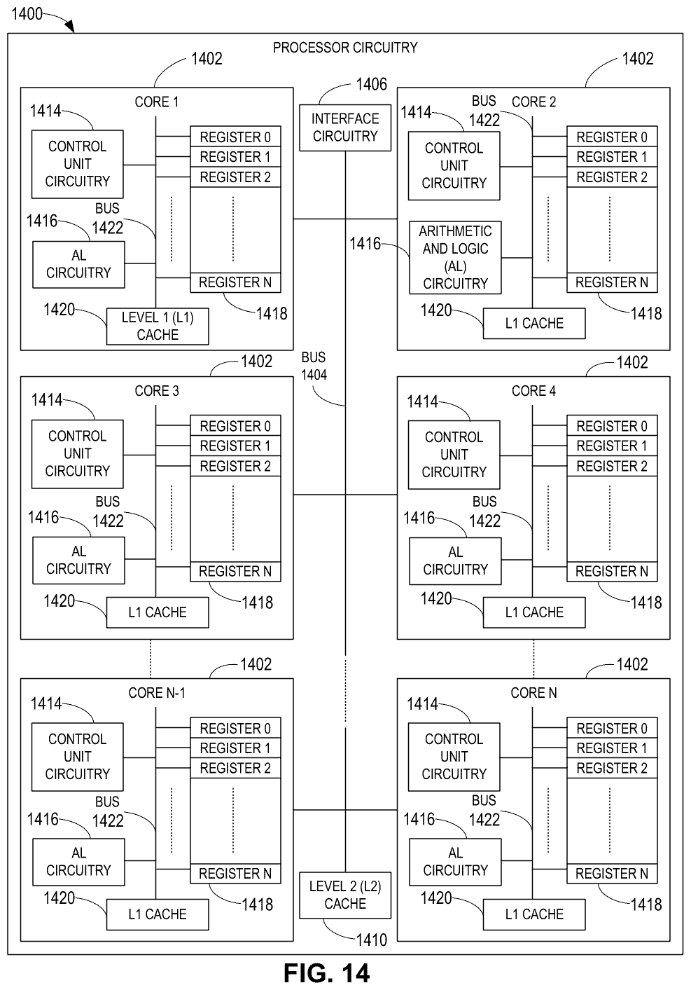

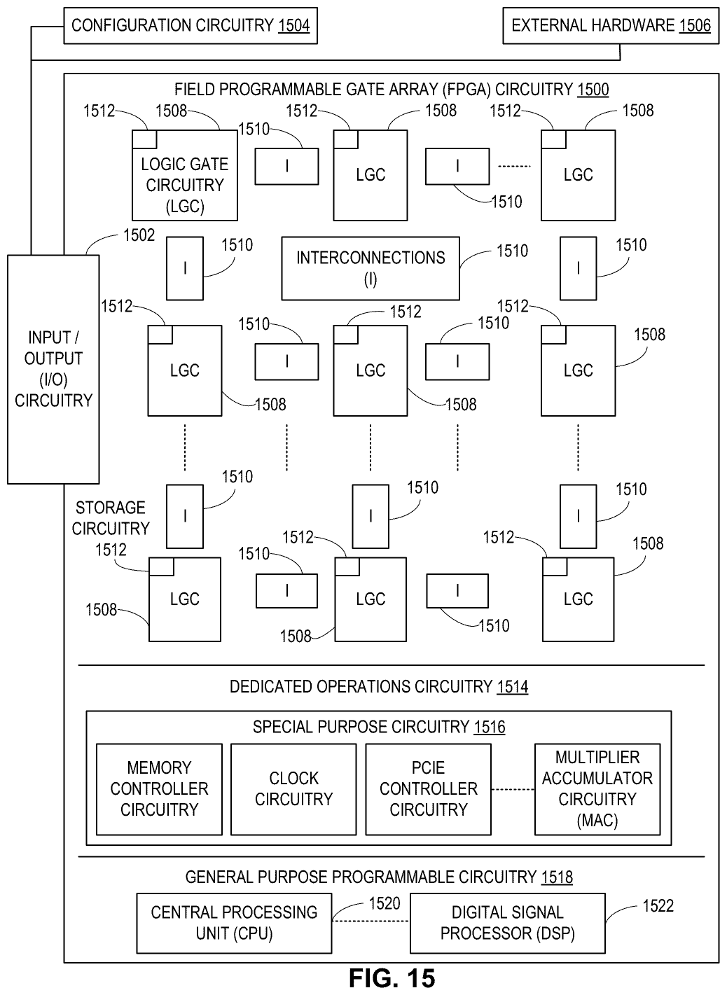

In some examples, the configuration controller 102 includes means for communicating. For example, the means for communicating may be implemented by communication interface circuitry 802. In some examples, the communication interface circuitry 802 may be instantiated by programmable circuitry such as the example programmable circuitry 1312 of FIG. 13. For instance, the communication interface circuitry 802 may be instantiated by the example microprocessor 1400 of FIG. 14 executing machine executable instructions such as those implemented by at least block 1008 of FIG. 10. In some examples, the communication interface circuitry 802 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the communication interface circuitry 802 may be instantiated by any other combination of hardware, software, and/or firmware. For example, the communication interface circuitry 802 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The key generator circuitry 804 is provided to generate signing keys. In some examples, the key generator circuitry 804 is instantiated by programmable circuitry executing key generator instructions and/or configured to perform operations such as those represented by the flowcharts of FIGS. 9-12.

In some examples, the configuration controller 102 includes means for generating keys. For example, the means for generating keys may be implemented by key generator circuitry 804. In some examples, the key generator circuitry 804 may be instantiated by programmable circuitry such as the example programmable circuitry 1312 of FIG. 13. For instance, the key generator circuitry 804 may be instantiated by the example microprocessor 1400 of FIG. 14 executing machine executable instructions such as those implemented by at least block 1004 of FIG. 10. In some examples, the key generator circuitry 804 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the key generator circuitry 804 may be instantiated by any other combination of hardware, software, and/or firmware. For example, the key generator circuitry 804 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The cryptography controller circuitry 806 is provided to generate security certificates, encrypt data, decrypt data, generate hashes, generate signatures, and perform authentication verifications. In some examples, the cryptography controller circuitry 806 is instantiated by programmable circuitry executing cryptography controller instructions and/or configured to perform operations such as those represented by the flowcharts of FIGS. 9-12.

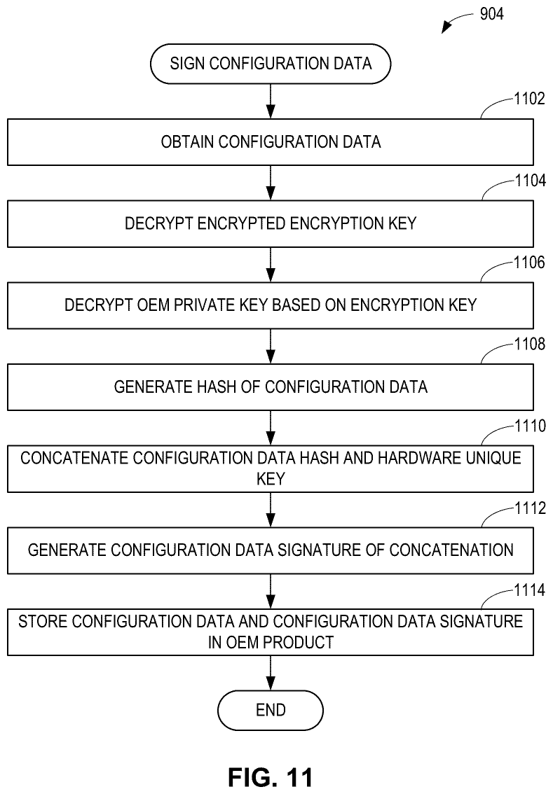

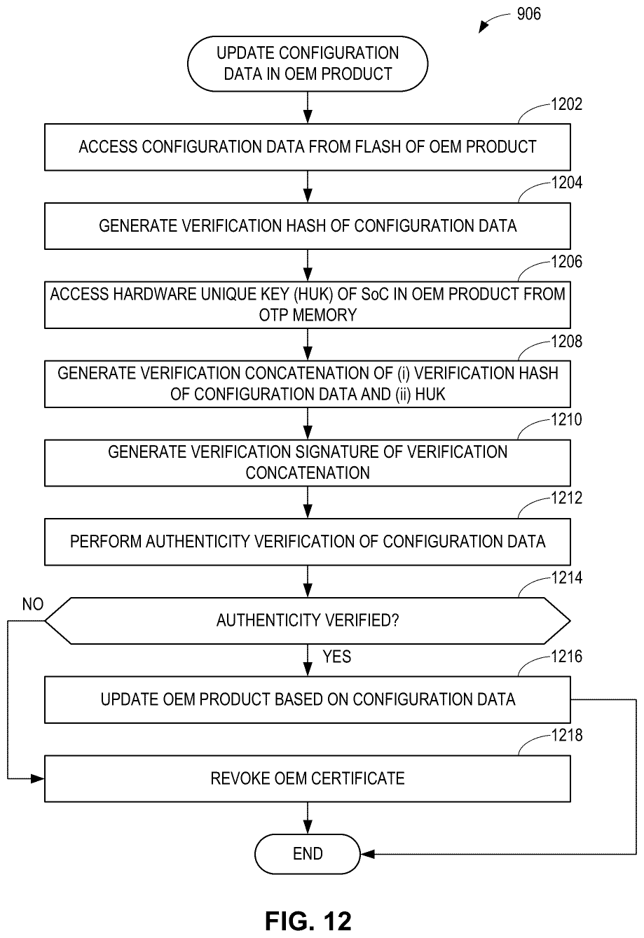

In some examples, the configuration controller 102 includes means for performing cryptography. For example, the means for performing cryptography may be implemented by the cryptography controller circuitry 806. In some examples, the cryptography controller circuitry 806 may be instantiated by programmable circuitry such as the example programmable circuitry 1312 of FIG. 13. For instance, the cryptography controller circuitry 806 may be instantiated by the example microprocessor 1400 of FIG. 14 executing machine executable instructions such as those implemented by at least blocks 1002 and 1006 of FIG. 10; blocks 1104, 1106, 1108, and 1112 of FIG. 11; and blocks 1204, 1210, 1212, 1214, and 1218 of FIG. 12. In some examples, the cryptography controller circuitry 806 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the cryptography controller circuitry 806 may be instantiated by any other combination of hardware, software, and/or firmware. For example, the cryptography controller circuitry 806 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The AL circuitry 808 is provided to perform arithmetic and logic operations. In some examples, the AL circuitry 808 is instantiated by programmable circuitry executing AL instructions and/or configured to perform operations such as those represented by the flowcharts of FIGS. 9-12. In some examples, the AL circuitry 808 is instantiated by programmable circuitry executing AL instructions and/or configured to perform operations such as those represented by the flowcharts of FIGS. 9-12.

In some examples, the configuration controller 102 includes means for performing arithmetic and logic operations (e.g., means for concatenating). For example, the means for performing arithmetic and logic operations may be implemented by the AL circuitry 808. In some examples, the AL circuitry 808 may be instantiated by programmable circuitry such as the example programmable circuitry 1312 of FIG. 13. For instance, the AL circuitry 808 may be instantiated by the example microprocessor 1400 of FIG. 14 executing machine executable instructions such as those implemented by at least block 1110 of FIG. 11 and block 1208 of FIG. 12. In some examples, the AL circuitry 808 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the AL circuitry 808 may be instantiated by any other combination of hardware, software, and/or firmware. For example, the AL circuitry 808 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The memory interface circuitry 810 is provided to access information (e.g., write information, read information, modify information, etc.) in memory and/or storage. In some examples, the memory interface circuitry 810 is instantiated by programmable circuitry executing memory interface instructions and/or configured to perform operations such as those represented by the flowcharts of FIGS. 9-12.

In some examples, the configuration controller 102 includes means for accessing memory. For example, the means for accessing memory may be implemented by the memory interface circuitry 810. In some examples, the memory interface circuitry 810 may be instantiated by programmable circuitry such as the example programmable circuitry 1312 of FIG. 13. For instance, the memory interface circuitry 810 may be instantiated by the example microprocessor 1400 of FIG. 14 executing machine executable instructions such as those implemented by at least block 1010 of FIG. 10; block 1114 of FIG. 11; and blocks 1202, 1206, and 1216 of FIG. 12. In some examples, the memory interface circuitry 810 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the memory interface circuitry 810 may be instantiated by any other combination of hardware, software, and/or firmware. For example, the memory interface circuitry 810 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the configuration controller 102 of FIG. 1 is illustrated in FIG. 8, one or more of the elements, processes, and/or devices illustrated in FIG. 8 may be combined, divided, re-arranged, omitted, eliminated, and/or implemented in any other way. Further, the example communication interface circuitry 802, the example key generator circuitry 804, the example cryptography controller circuitry 806, the example AL circuitry 808, and the example memory interface circuitry 810, and/or, more generally, the example configuration controller 102 of FIG. 8, may be implemented by hardware alone or by hardware in combination with software and/or firmware. Thus, for example, any of the example communication interface circuitry 802, the example key generator circuitry 804, the example cryptography controller circuitry 806, the example AL circuitry 808, and the example memory interface circuitry 810, and/or, more generally, the example configuration controller 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example configuration controller 102 of FIG. 8 may include one or more elements, processes, and/or devices in addition to, or instead of, those illustrated in FIG. 8, and/or may include more than one of any or all of the illustrated elements, processes and devices.

Flowcharts representative of example machine readable instructions, which may be executed by programmable circuitry to implement and/or instantiate the configuration controller 102 of FIG. 8 and/or representative of example operations which may be performed by programmable circuitry to implement and/or instantiate the configuration controller 102 of FIG. 8, are shown in FIGS. 9-12. The machine readable instructions may be one or more executable programs or portion(s) of one or more executable programs for execution by programmable circuitry such as the programmable circuitry 1312 shown in the example processor platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 9-12, many other methods of implementing the example configuration controller 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 9-12 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 9 is a flowchart representative of example machine readable instructions and/or example operations 900 that may be executed, instantiated, and/or performed by example programmable circuitry to implement the configuration controller of FIG. 8 to securely perform configuration updates of OEM products and/or associated systems. The example machine-readable instructions and/or the example operations 900 of

FIG. 9 begin at block 902, at which the configuration controller 102 obtains a signed OEM certificate. For example, the configuration controller 102 may obtain the signed OEM certificate 336 (FIG. 3) from the silicon provider 112 during the generation and certificate signing phase 206 as described above in connection with FIG. 3. Example operations and/or instructions that may be used to implement block 902 are described below in connection with FIG. 10.

At block 904, the configuration controller 102 signs configuration data. For example, the configuration controller 102 can sign the configuration data 402 (FIG. 4) during the sign configuration data phase 208 as described above in connection with FIG. 4 and/or FIG. 7. Example operations and/or instructions that may be used to implement block 904 are described below in connection with FIG. 11. At block 906, the configuration controller 102 performs an update based on the configuration data. For example, the configuration controller 102 can perform an update based on the configuration data 402 during the configuration data verification and update phase 212 as described above in connection with FIG. 5. Example operations and/or instructions that may be used to implement block 906 are described below in connection with FIG. 12.

FIG. 10 is a flowchart representative of example machine readable instructions and/or example operations 902 that may be executed, instantiated, and/or performed by example programmable circuitry to implement the configuration controller 102 of FIG. 8 to obtain a signature of an OEM certificate. The instructions and/or operations may be executed during the generation and certificate signing phase 206 of FIG. 3. The instructions and/or operations 902 begin at block 1002 at which the cryptography controller circuitry 806 encrypts the encryption key (EKEY) 314 (FIG. 3). For example, the cryptography controller circuitry 806 encrypts the EKEY 314 based on the symmetric key (SKEY) 310 (FIG. 3) as described above in connection with FIG. 3 to generate the encrypted EKEY 318 (FIG. 3) and stores the encrypted EKEY 318 in the flash memory 126 of the OEM product 104.

At block 1004, the key generator circuitry 804 generates an OEM key-pair. For example, the key generator circuitry 804 generates the OPrK 324a and the OPuK 324b of FIG. 3. In some examples, the cryptography controller circuitry 806 also encrypts the OPrK 324a based on the EKEY 314 (e.g., as described above in connection with block 340 of FIG. 3) and the memory interface circuitry 810 stores the encrypted OPrK 342 in the flash memory 126 of the OEM product 104.

At block 1006, the cryptography controller circuitry 806 generates the OEM certificate 328 (FIG. 3) based on the OPuK 324b. At block 1008, the communication interface circuitry 802 sends the OEM certificate 328 for signature from the OEM product 104 to the silicon provider 112. For example, the communication interface circuitry 802 sends the OEM certificate 328 and a request for signature to the silicon provider 112 via the trusted channel 332. The signature request is to request that the silicon provider 112 sign the OEM certificate 328. As described above in connection with FIG. 3, the silicon provider 112 signs the OEM certificate 328 based on the SiPrK 304a to generate the signed OEM certificate 336. At block 1010, the memory interface circuitry 810 stores the signed OEM certificate 336 in the OEM product 104. For example, the memory interface circuitry 810 stores the signed OEM certificate 336 in the flash memory 126 of the OEM product 104. The example instructions and/or operations 902 of FIG. 10 end and control returns to a calling function or process such as the example instructions and/or operations 900 of FIG. 9.

FIG. 11 is a flowchart representative of example machine readable instructions and/or example operations 904 that may be executed, instantiated, and/or performed by example programmable circuitry to implement the configuration controller 102 of FIG. 8 to sign configuration data for an OEM product (e.g., the OEM product 104 of FIGS. 1-5). The instructions and/or operations 904 may be executed during a configuration data signature phase such as the sign configuration data phase 208 described above in connection with FIG. 4 and/or FIG. 7. As such, the instructions and/or operations 904 may be executed in connection with the configuration data 402 and the signature metadata 416 of FIG. 4 and/or in connection with the configuration data 702 and the signature metadata 716 of FIG. 7. However, for purposes of brevity, the instructions and/or operations 904 are described in connection with the configuration data 402 and the signature metadata 416 of FIG. 4.

The instructions and/or operations 904 begin at block 1102 at which the memory interface circuitry 810 obtains or accesses the configuration data 402. At block 1104, the cryptography controller circuitry 806 decrypts the encrypted EKEY 318 (FIG. 3). For example, the cryptography controller circuitry 806 decrypts the encrypted EKEY 318 based on the SKEY 310 (FIGS. 3 and 4) to recover the EKEY 314 (FIGS. 3 and 4).

At block 1106, the cryptography controller circuitry 806 decrypts the OPrK 324a based on the EKEY 314. At block 1108, the cryptography controller circuitry 806 generates a hash of the configuration data 402 (e.g., a configuration data hash). At block 1110 the AL circuitry 808 concatenates (i) the configuration data hash and (ii) the HUK 308 (FIGS. 3 and 4). For example, the memory interface circuitry 810 accesses the HUK 308 from the OTP memory 124 of the SoC 122 in the OEM product 104. At block 1112, the cryptography controller circuitry 806 generates a configuration data signature of the concatenation of the configuration data hash and the HUK 308 from block 1110. For example, the cryptography controller circuitry 806 generates the configuration data signature as the signature metadata 416, which includes the signature of the concatenated configuration data hash and the HUK 308.

At block 1114, the memory interface circuitry 810 stores the configuration data 402 and the configuration data signature in the OEM product 104. For example, the memory interface circuitry 810 stores the configuration data signature as the signature metadata 416 in association with the configuration data 402 in the flash memory 126 of the OEM product 104. The example instructions and/or operations 904 end and control returns to a calling function or process such as the example instructions and/or operations 900 of FIG. 9.

FIG. 12 is a flowchart representative of example machine

readable instructions and/or example operations 906 that may be executed, instantiated, and/or performed by example programmable circuitry to implement the configuration controller 102 of FIG. 8 to update configuration data in an OEM product (e.g., the OEM product 104 of FIGS. 1-5). The instructions and/or operations 906 may be executed during the configuration data verification and update phase 212 described above in connection with FIG. 5. The instructions and/or operations 906 may be executed in connection with the configuration data 402 and the signature metadata 416 of FIG. 4 and/or in connection with the configuration data 702 and the signature metadata 716 of FIG. 7. However, for purposes of brevity, the instructions and/or operations 906 are described in connection with the configuration data 402 and the signature metadata 416 of FIG. 4.

The instructions and/or operations 906 begin at block 1202 at which the memory interface circuitry 810 accesses the configuration data 402 (FIG. 4) from the flash memory 126 of the OEM product 104. At block 1204, the cryptography controller circuitry 806 generates a verification hash of the configuration data 402. For example, the cryptography controller circuitry 806 generates the verification hash of the configuration data 402 based on the OPuK 324b (FIG. 5). At block 1206, the memory interface circuitry 810 accesses the HUK 308 of the SoC 122 in the OEM product 104 from the OTP memory 124. At block 1208, the cryptography controller circuitry 806 generates a verification concatenation of (i) the verification hash of the configuration data 402 and (ii) the HUK 308. At block 1210 the cryptography controller circuitry 806 generates a verification signature of the verification concatenation. For example, the cryptography controller circuitry 806 generates the verification signature of the verification concatenation based on the OPuK 324b.

At block 1212, the cryptography controller circuitry 806 performs authenticity verification of the configuration data 402. For example, the cryptography controller circuitry 806 performs the verification of the authenticity of the configuration data 402 based on a comparison of (i) the configuration data signature in the signature metadata 416 from the flash memory 126 and (ii) the verification configuration data signature generated at block 1210. If the cryptography controller circuitry 806 determines that the authenticity of the configuration data 402 is verified (block 1214: YES), the memory interface circuitry 810 updates the OEM product 104 based on the configuration data 402 (block 1216). For example, the memory interface circuitry 810 updates the OEM product 104 by writing the configuration data 402 to a designated memory area of the OEM product 104. In some examples, at block 1216, the memory interface circuitry 810 additionally or alternatively updates the system 106 in which the OEM product 104 is located. If the cryptography controller circuitry 806 determines that the authenticity of the configuration data 402 is not verifiable (block 1214: NO), the cryptography controller circuitry 806 revokes the OEM certificate 328 at block 1218. In such instances, the cryptography controller circuitry 806 also rejects use of the configuration data 402 for an update (e.g., a denial of service). The instructions and/or operations 906 end and control returns to a calling function or process such as the example instructions and/or operations 900 of FIG. 9.

FIG. 13 is a block diagram of an example programmable

circuitry platform 1300 structured to execute and/or instantiate the example machine-readable instructions and/or the example operations of FIGS. 9-12 to implement the configuration controller 102 of FIG. 8. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, DSPs, and/or microcontrollers from any desired family or manufacturer. The programmable circuitry 1312 may be implemented by one or more semiconductor based (e.g., silicon based) devices. In this example, the programmable circuitry 1312 implements the example communication interface circuitry 802, the example key generator circuitry 804, the example cryptography controller circuitry 806, the example AL circuitry 808, and the example memory interface circuitry 810.

The programmable circuitry 1312 of the illustrated example

includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1332, which may be implemented by the machine readable instructions of FIGS. 9-12, may be stored in the mass storage device 1328, in the volatile memory 1314, in the non-volatile memory 1316, and/or on at least one non-transitory computer readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 9-12 to effectively instantiate the circuitry of FIG. 8 as logic circuits to perform operations corresponding to those machine readable instructions. In some such examples, the circuitry of FIG. 8 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowcharts of FIGS. 9-12.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine readable instructions represented by the flowchart(s) of FIGS. 9-12 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 9-12. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9-12. As such, the FPGA circuitry 1500 may be configured and/or structured to effectively instantiate some or all of the operations/functions corresponding to the machine readable instructions of the flowchart(s) of FIGS. 9-12 as dedicated logic circuits to perform the operations/functions corresponding to those software instructions in a dedicated manner analogous to an ASIC. Therefore, the FPGA circuitry 1500 may perform the operations/functions corresponding to the some or all of the machine readable instructions of FIGS. 9-12 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine readable instructions of FIGS. 9-12 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 14. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine readable instructions represented by the flowchart(s) of FIGS. 9-12 to perform first operation(s)/function(s), the FPGA circuitry 1500 of FIG. 15 may be configured and/or structured to perform second operation(s)/function(s) corresponding to a second portion of the machine readable instructions represented by the flowcharts of FIG. 9-12, and/or an ASIC may be configured and/or structured to perform third operation(s)/function(s) corresponding to a third portion of the machine readable instructions represented by the flowcharts of FIGS. 9-12.

It should be understood that some or all of the circuitry of FIG. 8 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIG. 8 may be instantiated, for example, in one or more threads executing concurrently and/or in series. For example, the microprocessor 1400 of FIG. 14 may execute machine readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIG. 8 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

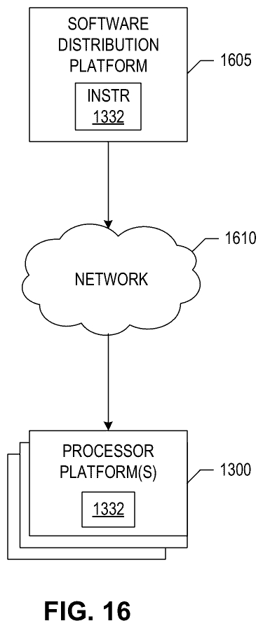

A block diagram illustrating an example software distribution platform 1605 to distribute software such as the example machine readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine readable instructions 1332, which may correspond to the example machine readable instructions of FIGS. 9-12, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1332 from the software distribution platform 1605. For example, the software, which may correspond to the example machine readable instructions of FIG. 9-12, may be downloaded to the example programmable circuitry platform 1300, which is to execute the machine readable instructions 1332 to implement the configuration controller 102. In some examples, one or more servers of the software distribution platform 1605 periodically offer, transmit, and/or force updates to the software (e.g., the example machine readable instructions 1332 of FIG. 13) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that securely perform configuration updates. Disclosed systems, apparatus, articles of manufacture, and methods improve the efficiency of using a computing device by pushing product configuration data in-field in a manner that makes that product configuration data protected from tampering and only allowed by trusted entities (e.g., OEM product manufacturers, system manufacturers, and system integrators). Examples disclosed herein provide capabilities to securely perform in-field updates (e.g., performed by authorized third parties at customer sites without intervention by silicon providers and/or OEM product manufacturers) by signing configuration settings including production-stage configuration settings developed by third parties outside of OEM product manufacturers and silicon providers. Examples disclosed herein accomplish this without the need to verify the trusted entities in-field. Accordingly, examples disclosed herein reduce computing and/or network resource usage by OEM products (and/or systems that incorporate the OEM product post-production) when performing in-field configuration updates by not needing to communicate with a silicon provider or other third-party security verification entity to perform in-field verification of a source or provider of configuration data. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to securely perform configuration updates are disclosed herein. Further examples and combinations thereof include the following:

Example 1 includes an apparatus comprising interface circuitry, machine-readable instructions, and at least one processor circuit to be programmed by the machine-readable instructions to generate an original equipment manufacturer (OEM) private key and an OEM public key, generate an OEM certificate based on the OEM public key, cause sending of the OEM certificate from an OEM product to a silicon provider, the silicon provider to sign the OEM certificate based on a silicon provider private key, and cause storage of the signed OEM certificate in the OEM product.

Example 2 includes the apparatus of example 1, wherein one or more of the at least one processor circuit is to encrypt an encryption key based on a symmetric key to generate an encrypted encryption key, encrypt the OEM private key based on the encryption key, and cause storage of the encrypted OEM private key and the encrypted encryption key in the OEM product.

Example 3 includes the apparatus of at least one of example 1 or example 2, wherein one or more of the at least one processor circuit is to access configuration data, perform an authenticity verification process of the configuration data based on the OEM public key, and at least one of: after authenticity of the configuration data is verified, update the OEM product based on the configuration data, or after the authenticity of the configuration data is not verified, revoke the OEM certificate.

Example 4 includes the apparatus of at least one of examples 1-3, wherein the OEM product is a safety camera to be used with a robot, and the configuration data is to define a zone to be monitored by the safety camera during operation of the robot.

Example 5 includes the apparatus of at least one of examples 1-4, including a chip having a one-time programmable (OTP) memory, and, to verify the authenticity of the configuration data, one or more of the at least one processor circuit is to access a hardware unique key of the chip from the OTP memory, and verify the authenticity of the configuration data based on a concatenation of the hardware unique key and a hash of the configuration data.

Example 6 includes the apparatus of at least one of examples 1-5, wherein, during a configuration data signature phase, one or more of the at least one processor circuit is to decrypt an encrypted encryption key based on a symmetric key to recover the encryption key, decrypt the OEM private key based on the encryption key, generate a configuration data signature of a concatenation of (i) a first hash of configuration data and (ii) a hardware unique key, the hardware unique key from an OTP memory in the OEM product, and cause storage of the configuration data and the configuration data signature in the OEM product.

Example 7 includes the apparatus of at least one of examples 1-6, wherein the configuration data signature is a first configuration data signature and, during a configuration data verification and update phase, one or more of the at least one processor circuit is to access the configuration data, generate a second hash of the configuration data, generate a second concatenation of (i) the second hash of the configuration data and (ii) the hardware unique key, verify authenticity of the configuration data based on the first configuration data signature and a second configuration data signature of the second concatenation, and update the OEM product based on the configuration data.

Example 8 includes the apparatus of at least one of examples 1-7, wherein one or more of the at least one processor circuit is to update the OEM product based on the configuration data provided by at least one of (a) a system manufacturer that incorporates the OEM product into a system or (b) a system integrator that integrates the system into a customer solution.

Example 9 includes at least one non-transitory machine-readable medium comprising machine-readable instructions to cause at least one processor circuit to at least generate an original equipment manufacturer (OEM) private key and an OEM public key, generate an OEM certificate based on the OEM public key, cause sending of the OEM certificate from an OEM product to a silicon provider, the silicon provider to sign the OEM certificate based on a silicon provider private key, and cause storage of the signed OEM certificate in the OEM product.

Example 10 includes the at least one non-transitory machine-readable medium of example 9, wherein the machine-readable instructions are to cause one or more of the at least one processor circuit to encrypt an encryption key based on a symmetric key to generate an encrypted encryption key, encrypt the OEM private key based on the encryption key, and cause storage of the encrypted OEM private key and the encrypted encryption key in the OEM product.

Example 11 includes the at least one non-transitory machine-readable medium of at least one of example 9 or example 10, wherein the machine-readable instructions are to cause one or more of the at least one processor circuit to access configuration data, perform an authenticity verification process of the configuration data based on the OEM public key, and after authenticity of the configuration data is verified, update the OEM product based on the configuration data.

Example 12 includes the at least one non-transitory machine-readable medium of at least one of examples 9-11, wherein the machine-readable instructions are to cause one or more of the at least one processor circuit to access configuration data, perform an authenticity verification process of the configuration data based on the OEM public key, and after authenticity of the configuration data is not verified, revoke the OEM certificate.

Example 13 includes the at least one non-transitory machine-readable medium of at least one of examples 9-12, wherein the machine-readable instructions are to cause one or more of the at least one processor circuit to perform the authenticity verification process of the configuration data by accessing a hardware unique key of a chip from a one-time programmable (OTP) memory of the chip, and verifying the authenticity of the configuration data based on a concatenation of the hardware unique key and a hash of the configuration data.

Example 14 includes the at least one non-transitory machine-readable medium of at least one of examples 9-13, wherein, during a configuration data signature phase, the machine-readable instructions are to cause one or more of the at least one processor circuit to decrypt an encrypted encryption key based on a symmetric key to recover the encryption key, decrypt the OEM private key based on the encryption key, generate a configuration data signature of a concatenation of (i) a first hash of configuration data and (ii) a hardware unique key, the hardware unique key from an OTP memory in the OEM product, and cause storage of the configuration data and the configuration data signature in the OEM product.

Example 15 includes the at least one non-transitory machine-readable medium of at least one of examples 9-14, wherein the configuration data signature is a first configuration data signature and, during a configuration data verification and update phase, the machine-readable instructions are to cause one or more of the at least one processor circuit to access the configuration data, generate a second hash of the configuration data, generate a second concatenation of (i) the second hash of the configuration data and (ii) the hardware unique key, verify authenticity of the configuration data based on the first configuration data signature and a second configuration data signature of the second concatenation, and update the OEM product based on the configuration data.

Example 16 includes the at least one non-transitory machine-readable medium of at least one of examples 9-15, wherein the machine-readable instructions are to cause one or more of the at least one processor circuit to update the OEM product based on the configuration data provided by at least one of (a) a system manufacturer that incorporates the OEM product into a system or (b) a system integrator that integrates the system into a customer solution.

Example 17 includes an apparatus comprising key generator circuitry to generate an original equipment manufacturer (OEM) key pair, the OEM key pair including an OEM private key and an OEM public key, communication interface circuitry to send an OEM certificate from an OEM product to a silicon provider, the silicon provider to sign the OEM certificate based on a silicon provider private key, and memory interface circuitry to cause storage of the signed OEM certificate in the OEM product.

Example 18 includes the apparatus of example 17, including cryptography controller circuitry, the cryptography controller circuitry to encrypt an encryption key based on a symmetric key to generate an encrypted encryption key, and encrypt the OEM private key based on the encryption key, and the memory interface circuitry is to cause storage of the encrypted OEM private key and the encrypted encryption key in the OEM product.

Example 19 includes the apparatus of at least one of examples 17 or 18, including cryptography controller circuitry, the cryptography controller circuitry is to decrypt an encrypted encryption key based on a symmetric key to recover the encryption key, decrypt the OEM private key based on the encryption key, and generate a configuration data signature of a concatenation of (i) a first hash of configuration data and (ii) a hardware unique key, the hardware unique key from an OTP memory in the OEM product, and the memory interface circuitry is to cause storage of the configuration data and the configuration data signature in the OEM product.

Example 20 includes the apparatus of at least one of examples 17-19, wherein the cryptography controller circuitry is to generate a second hash of the configuration data, generate a second concatenation of (i) the second hash of the configuration data and (ii) the hardware unique key, and verify authenticity of the configuration data based on the configuration data signature and a second configuration data signature of the second concatenation, and the memory interface circuitry is to update the OEM product based on the configuration data.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
generate an original equipment manufacturer (OEM) private key and an OEM public key;
generate an OEM certificate based on the OEM public key;
cause sending of the OEM certificate from an OEM product to a silicon provider, the silicon provider to sign the OEM certificate based on a silicon provider private key; and
cause storage of the signed OEM certificate in the OEM product.

2. The apparatus of claim 1, wherein one or more of the at least one processor circuit is to:
encrypt an encryption key based on a symmetric key to generate an encrypted encryption key;
encrypt the OEM private key based on the encryption key; and
cause storage of the encrypted OEM private key and the encrypted encryption key in the OEM product.

3. The apparatus of claim 1, wherein one or more of the at least one processor circuit is to:
access configuration data;
perform an authenticity verification process of the configuration data based on the OEM public key; and at least one of:
after authenticity of the configuration data is verified, update the OEM product based on the configuration data; or
after the authenticity of the configuration data is not verified, revoke the OEM certificate.

4. The apparatus of claim 3, wherein the OEM product is a safety camera to be used with a robot, and the configuration data is to define a zone to be monitored by the safety camera during operation of the robot.

5. The apparatus of claim 3, including a chip having a one-time programmable (OTP) memory, and, to verify the authenticity of the configuration data, one or more of the at least one processor circuit is to:
access a hardware unique key of the chip from the OTP memory; and
verify the authenticity of the configuration data based on a concatenation of the hardware unique key and a hash of the configuration data.

6. The apparatus of claim 1, wherein, during a configuration data signature phase, one or more of the at least one processor circuit is to:
decrypt an encrypted encryption key based on a symmetric key to recover the encryption key;
decrypt the OEM private key based on the encryption key;
generate a configuration data signature of a concatenation of (i) a first hash of configuration data and (ii) a hardware unique key, the hardware unique key from an OTP memory in the OEM product; and
cause storage of the configuration data and the configuration data signature in the OEM product.

7. The apparatus of claim 6, wherein the configuration data signature is a first configuration data signature and, during a configuration data verification and update phase, one or more of the at least one processor circuit is to:
access the configuration data;
generate a second hash of the configuration data;
generate a second concatenation of (i) the second hash of the configuration data and (ii) the hardware unique key;
verify authenticity of the configuration data based on the first configuration data signature and a second configuration data signature of the second concatenation; and
update the OEM product based on the configuration data.

8. The apparatus of claim 7, wherein one or more of the at least one processor circuit is to update the OEM product based on the configuration data provided by at least one of: (a) a system manufacturer that incorporates the OEM product into a system or (b) a system integrator that integrates the system into a customer solution.

9. At least one non-transitory machine-readable medium comprising machine-readable instructions to cause at least one processor circuit to at least:
generate an original equipment manufacturer (OEM) private key and an OEM public key;
generate an OEM certificate based on the OEM public key;
cause sending of the OEM certificate from an OEM product to a silicon provider, the silicon provider to sign the OEM certificate based on a silicon provider private key; and
cause storage of the signed OEM certificate in the OEM product.

10. The at least one non-transitory machine-readable medium of claim 9, wherein the machine-readable instructions are to cause one or more of the at least one processor circuit to:
encrypt an encryption key based on a symmetric key to generate an encrypted encryption key;
encrypt the OEM private key based on the encryption key; and
cause storage of the encrypted OEM private key and the encrypted encryption key in the OEM product.

11. The at least one non-transitory machine-readable medium of claim 9, wherein the machine-readable instructions are to cause one or more of the at least one processor circuit to:
access configuration data;
perform an authenticity verification process of the configuration data based on the OEM public key; and
after authenticity of the configuration data is verified, update the OEM product based on the configuration data.

12. The at least one non-transitory machine-readable medium of claim 9, wherein the machine-readable instructions are to cause one or more of the at least one processor circuit to:
access configuration data;
perform an authenticity verification process of the configuration data based on the OEM public key; and
after authenticity of the configuration data is not verified, revoke the OEM certificate.

13. The at least one non-transitory machine-readable medium of claim 11, wherein the machine-readable instructions are to cause one or more of the at least one processor circuit to perform the authenticity verification process of the configuration data by:
accessing a hardware unique key of a chip from a one-time programmable (OTP) memory of the chip; and
verifying the authenticity of the configuration data based on a concatenation of the hardware unique key and a hash of the configuration data.

14. The at least one non-transitory machine-readable medium of claim 9, wherein, during a configuration data signature phase, the machine-readable instructions are to cause one or more of the at least one processor circuit to:
decrypt an encrypted encryption key based on a symmetric key to recover the encryption key;
decrypt the OEM private key based on the encryption key;
generate a configuration data signature of a concatenation of (i) a first hash of configuration data and (ii) a hardware unique key, the hardware unique key from an OTP memory in the OEM product; and
cause storage of the configuration data and the configuration data signature in the OEM product.

15. The at least one non-transitory machine-readable medium of claim 14, wherein the configuration data signature is a first configuration data signature and, during a configuration data verification and update phase, the machine-readable instructions are to cause one or more of the at least one processor circuit to:
access the configuration data;
generate a second hash of the configuration data;
generate a second concatenation of (i) the second hash of the configuration data and (ii) the hardware unique key;
verify authenticity of the configuration data based on the first configuration data signature and a second configuration data signature of the second concatenation; and
update the OEM product based on the configuration data.

16. The at least one non-transitory machine-readable medium of claim 15, wherein the machine-readable instructions are to cause one or more of the at least one processor circuit to update the OEM product based on the configuration data provided by at least one of: (a) a system manufacturer that incorporates the OEM product into a system or (b) a system integrator that integrates the system into a customer solution.

17. An apparatus comprising:
key generator circuitry to generate an original equipment manufacturer (OEM) key pair, the OEM key pair including an OEM private key and an OEM public key;
communication interface circuitry to send an OEM certificate from an OEM product to a silicon provider, the silicon provider to sign the OEM certificate based on a silicon provider private key; and
memory interface circuitry to cause storage of the signed OEM certificate in the OEM product.

18. The apparatus of claim 17, including cryptography controller circuitry, the cryptography controller circuitry to:
encrypt an encryption key based on a symmetric key to generate an encrypted encryption key; and
encrypt the OEM private key based on the encryption key; and
the memory interface circuitry is to cause storage of the encrypted OEM private key and the encrypted encryption key in the OEM product.

19. The apparatus of claim 17, including cryptography controller circuitry, the cryptography controller circuitry is to:
decrypt an encrypted encryption key based on a symmetric key to recover the encryption key;
decrypt the OEM private key based on the encryption key; and
generate a configuration data signature of a concatenation of (i) a first hash of configuration data and (ii) a hardware unique key, the hardware unique key from an OTP memory in the OEM product; and
the memory interface circuitry is to cause storage of the configuration data and the configuration data signature in the OEM product.

20. The apparatus of claim 19, wherein:
the cryptography controller circuitry is to:
generate a second hash of the configuration data;
generate a second concatenation of (i) the second hash of the configuration data and (ii) the hardware unique key; and
verify authenticity of the configuration data based on the configuration data signature and a second configuration data signature of the second concatenation; and
the memory interface circuitry is to update the OEM product based on the configuration data.
